(19) United States
(12) Patent Application Publication
(10) Pub. No.: US 2019/0190996 A1
(43) Pub. Date: Jun. 20, 2019

(54) NETWORK SERVICE ACCESS CONTROL BY AUTHORIZATION SERVER

(71) Applicant: T-Mobile USA, Inc., Bellevue, WA (US)

(72) Inventors: Nassereddine Sabeur, Seattle, WA (US); Raymond Thomas Ball, Seattle, WA (US)

(21) Appl. No.: 15/848,844

(22) Filed: Dec. 20, 2017

(51) Int. Cl. H04L 29/08; H04W 8/12; H04W 8/16; H04W 8/18

(52) U.S. Cl. CPC H04L 67/16; H04W 8/183; H04W 8/16; H04W 8/12

(57) ABSTRACT

In some implementations, a telecommunications network can include an authorization server, e.g., a Diameter Routing Agent. The authorization server can receive service data associated with a network terminal from a home authorization server. The authorization server can determine that a portion of the service data corresponds with a predetermined network service and remove the portion of the service data to provide modified service data. The authorization server can transmit the modified service data to a control device of the network. In some examples, the control device can determine a gateway device identified in the modified service data and transmit an association message to the gateway device on behalf of the terminal. In some examples, the control device can receive a request for a network service from the terminal, determine that the modified service data does not authorize the network service, and transmit a rejection message to the terminal.

### BACKGROUND

Many computing devices configured for telecommunications, such as smartphones, are capable of processing various types and encodings of media and interacting with various network services in addition to, e.g., two-party voice telephone calls. Examples of such media or services can include video calling or multi-party conferencing. Cellular and other portable communication devices may connect with networks of varying capability either within a communication session or between communication sessions. Such networks can include home networks of those communication devices or visited networks in which those communication devices are roaming.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 is a block diagram illustrating a system for implementing network service access control, e.g., with respect to roaming terminals, according to some implementations.

FIG. 2 illustrates an example telecommunications network, including components used to perform service-access control of a communication session.

FIG. 3 is a block diagram illustrating a system that provides service-access control according to some implementations.

FIG. 4 shows an example call flow illustrating control of access to network services.

FIG. 5 shows an example call flow illustrating disallowing of access to unsupported network services.

FIG. 6 illustrates an example process for controlling access to network services according to some implementations.

FIG. 7 illustrates example processes for controlling access to network services according to some implementations.

FIG. 8 illustrates an example process for disallowing of access to unsupported network services.

FIG. 9 illustrates example processes for disallowing of access to unsupported network services, and providing access to supported network services.

FIG. 10 illustrates an example process for controlling network-service access by modifying service data, e.g., a subscriber's profile.

FIG. 11 shows an example call flow illustrating controlling network-service access by modifying service data.

FIG. 12 illustrates an example process for controlling network-service access by modifying service data.

FIG. 13 illustrates example processes for controlling network-service access by modifying service data.

FIG. 14 illustrates example processes for controlling network-service access using modified service data.

### DETAILED DESCRIPTION

### Overview

Some example systems and techniques described herein permit making effective use of available network bandwidth by controlling which services are provided over which networks to which computing devices. Some example systems and techniques described herein permit reducing bandwidth overload or network unavailability due to improper use of network services, e.g., by incorrectly operating communication devices.

As used herein, a “terminal” is a communication device, e.g., a cellular telephone or other user equipment (UE), configured to perform, or intercommunicate with systems configured to perform, techniques described herein. Terminals can include, e.g., wireless voice- or data-communication devices. A terminal can include a user interface (e.g., as does a smartphone), but is not required to. For example, a streaming server configured to provide audio or visual content on demand can be a terminal. Such a terminal may not include a user interface, and may instead respond to other terminals that form queries and send those queries to the server in response to actions taken via interfaces at those other terminals.

The term “session” as used herein includes a communications path for bidirectional exchange of data among two or more terminals. Example sessions include voice and video calls, e.g., by which human beings converse, a data communication session, e.g., between two electronic systems or between an electronic system and a human being, or a Rich Communication Suite (RCS, also known as JOYN) session. Some example systems and techniques herein can permit controlling which types of sessions can be carried on a particular network, e.g., a visited network. In some examples, the control is facilitated transparently to the intercommunicating terminals.

Example networks carrying sessions include second-generation (2G) cellular networks such as the Global System for Mobile Communications (GSM) and third-generation (3G) cellular networks such as the Universal Mobile Telecommunications System (UMTS). Other example networks include fourth-generation (4G) cellular networks, such as Long Term Evolution (LTE) cellular networks carrying voice over LTE (VoLTE) sessions using Session Initiation Protocol (SIP) signaling, the public switched telephone network (PSTN) using Signaling System 7 (SS7) signaling, and data networks, such as Institute of Electrical and Electronics Engineers (IEEE) 802.11 (WIFI) networks carrying voice over Internet Protocol (VoIP) calls or other over-the-top (OTT) sessions encapsulating, e.g., voice or video data in a way transparent to an underlying packet transport. GSM and the PSTN are examples of circuit-switched (CS) networks; LTE and WIFI are examples of packet-switched (PS) networks.

A terminal in a mobile-radio system, e.g., an association of public land mobile networks (PLMNs), is associated with a home network that maintains authorization information for that terminal. A terminal can receive communication services from the home network or from a visited network different from the home network. The term “roaming” describes operation of a terminal in a visited network. In some examples, a visited PLMN (VPLMN) retrieves service data from a home PLMN (HPLMN) for a terminal roaming in the VPLMN. The VPLMN also provides information to the terminal regarding whether services such as PS voice (e.g., VoLTE) are available. However, some terminals may disregard the information from the VPLMN and attempt to access services indicated in the service data as supported by the HPLMN, even if those services are not supported by the VPLMN. For example, a terminal may disregard a “PS voice supported” indication from a Mobility Management Entity (MME) of the VPLMN if the service data from the HPLMN identifies a home-network server that provides PS voice services. In some prior schemes, a terminal may be able to establish a network tunnel to an HPLMN to obtain services, even if those services are not supported by the VPLMN. This can result in overuse of bandwidth, increased network load, decreased network availability, and negative effects on throughput or packet-loss rate of sessions at other terminals.

In some examples, a control device of a telecommunications network, e.g., an MME of a VPLMN, modifies service data provided by a home authorization server, e.g., of the HPLMN, to remove portion(s) of the service data representing service(s) not supported by the VPLMN. The control device can, e.g., associate with supported service-providing gateway devices on behalf of the terminal. Additionally or alternatively, the control device can reject attempts by terminals to access services not supported by the VPLMN.

In some examples, an authorization server of a telecommunications network, e.g., a Diameter Routing Agent (DRA) of a VPLMN, modifies the service data to remove indications of service(s) not supported by the VPLMN. The authorization server can be used in conjunction with a control device to permit associating with gateway devices for supported services, or to permit rejecting requests for unsupported services.

Some examples herein provide improved access control of telecommunications networks, such as VPLMNs, which can reduce the chance of unauthorized use. Some examples permit restricting access to services for which the telecommunications network is not provisioned. This can reduce network load and increase availability of permitted services. In some examples, modifying the service data can prevent tunnels associated with unsupported services from being established between a roaming terminal and an HPLMN. This can increase network reliability of the VPLMN and reduce the extent to which other sessions may experience reduced throughput or higher packet-loss rates due to the unsupported traffic that might otherwise flow through such a tunnel. This can also permit supporting a higher number of concurrent sessions at a given quality of service (QoS).

Some examples herein can prevent network services from being provided over networks not provisioned to carry those services. This can reduce network load and improve session data-transfer quality. For example, a network operator may deploy a PS voice network that provides a guaranteed QoS, and a separate general-purpose data network that does not provide voice-grade QoS. In some prior schemes, misbehaving terminals may establish tunnels by which PS voice services are routed over the general-purpose network. However, the call quality for these calls is reduced compared to the quality of calls carried on the voice-grade network. Moreover, a voice call may occupy a disproportionately large fraction of the available bandwidth on the general-purpose network, even though it would occupy a much smaller fraction of the bandwidth on the voice-grade network. Disallowing establishment of such tunnels permits routing calls and other sessions over the networks provisioned to provide the desired QoS for those sessions, and permits effectively sharing bandwidth on a network between the concurrent users of that network.

Some examples herein are described in the context of control by a visited network of access by a terminal roaming in that visited network to services offered by that terminal's home network. However, these examples are not limiting. Some examples herein can additionally or alternatively permit controlling access to network services within a home network, or between different networks that do not distinguish “home” from “visited.”

### Illustrative Configurations

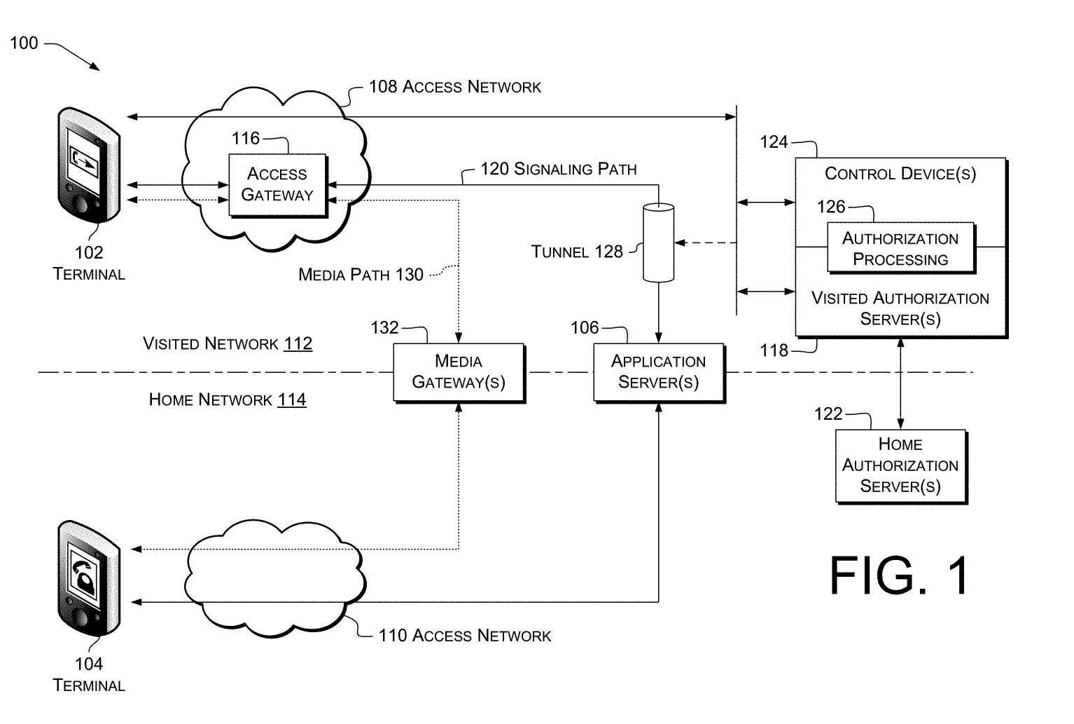

FIG. 1 is a block diagram illustrating a telecommunication system 100 according to some examples. The system includes terminals 102 and 104, e.g., user equipment or other mobile phones, or other computing or communications devices. The terminals 102 and 104 can be operated, e.g., by respective users. The terminals 102 and 104 are communicatively connected to one or more application server(s) 106, e.g., via respective access networks 108 and 110. The application server(s) 106 can include, e.g., a telephony application server (TAS) of an Internet Protocol (IP) Multimedia Subsystem (IMS) in a VoLTE-capable network.

The terminals 102 and 104 may be implemented as any suitable mobile computing devices configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the terminals 102 and 104 as being “mobile” or “wireless,” (e.g., configured to be carried and moved around), it is to be appreciated that the terminals 102 and 104 may represent various types of communication devices that are generally stationary as well, such as televisions, desktop computers, game consoles, set top boxes, and the like. User equipment can include user cellular equipment or other telecommunications or computing devices communicatively connectable with other computing devices via one or more application server(s) 106. Mobile phones and copper-loop landline phones can be examples of user equipment.

In the illustrated example, terminal 102 is roaming in, or otherwise connected to, a visited network 112 having the access network 108. The visited network 112 can include a VPLMN. In some examples, visited network 112 can be or include an Evolved Packet System (EPS) network including Evolved UMTS Terrestrial Radio Access Network (E-UTRAN) access and an Evolved Packet Core (EPC).

In some examples, terminal 102 uses services located in, part of, or otherwise provided by, a home network 114. The home network 114 can include an HPLMN. In some examples, terminal 102 is configured so that any network other than home network 114 is a visited network such as visited network 112. In this example, terminal 104 is shown as attached to home network 114 for brevity, but this is not limiting. For example, terminal 104 can be roaming in visited network 112 or another network, or have a different home network and this be roaming in home network 114.

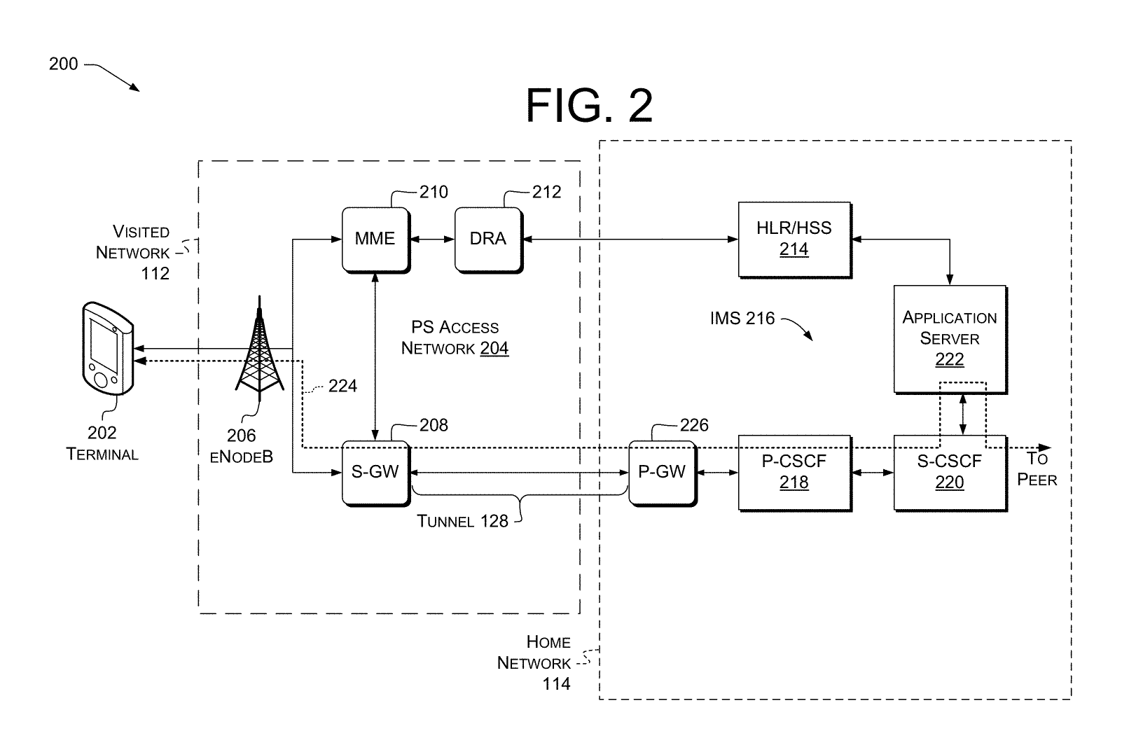

In some examples, at least one of visited network 112 or home network 114 can include a PS access network, e.g., as discussed herein with reference to FIG. 2. Additionally or alternatively, at least one of visited network 112 or home network 114 can include a local-area network (LAN)-based access network having a wireless access point (WAP), e.g., a WIFI WAP, and a bridge or other packet relay. Additionally or alternatively, at least one of visited network 112 or home network 114 can include a CS access network having a CS base station and a mobile switching center (MSC) server (MSS).

In some examples, access network 108 includes an access gateway 116. For example, an EPC access network 108 can include a serving gateway (S-GW) that functions as access gateway 116. In other examples, other components of access network 108 can provide the functions described herein with reference to access gateway 116.

In some examples, to attach to visited network 112, terminal 102 communicates with one or more visited authorization server(s) 118 to perform authorization processing. The communications can include, e.g., Diameter, Radio Resource Control (RRC), or S1 Application Protocol (S1-AP) messages transferred via a signaling path 120, and conveyed by access gateway 116. In some examples, the visited authorization server(s) 118 include an LTE MME or similar device, or a DRA or similar device.

Terminal 102 can provide identification information to the visited authorization server(s) 118. In some examples, the identification information can includes at least one of: a terminal identifier such as an international mobile equipment identity (IMEI), a network identifier such as a mobile country code (MCC) and a mobile network code (MNC), a user identifier such as an international mobile subscriber identity (IMSI), a user address such as an E.164 international-dialing-plan telephone number, mobile station international subscriber directory number (MSISDN), a network address, such as an Internet IPv4 or IPv6 address, or a country code, e.g., indicating a country in which terminal 302 is located. In some examples, the identification information can include an identifier of a Mobile virtual network operator (MVNO) determined from the IMSI of terminal 102. In some examples, terminal 102 can provide the identification information during a process of attaching to a network, e.g., in an SlAP Initial UE Message. In some examples, terminal 102 can provide the identification information in another message. For example, a SIP REGISTER request or a SIP INVITE request can include a P-Access-Network-Info (PANI) header. The cell global identity (CGI) of the cell (e.g., eNodeB) serving the terminal 102 can be retrieved from the “cgi-3gpp” parameter of the PANI header. The cgi-3gpp parameter can include the MCC, MNC, location area code (LAC), and cell identity (CI).

Visited authorization server(s) 118 can determine the identity of one or more home authorization server(s) 122 in home network 114 based on the identification information. Home authorization server(s) 122 can include, e.g., a DRA, a home location register (HLR), or a home subscriber server (HSS). In some examples, an IMSI includes an MCC and an MNC. Visited authorization server(s) 118 can determine a network address of an HSS based at least in part on the MCC and MNC, e.g., by querying the GSMA Roaming Database (GSMA IR.21) for the LTE Roaming section, which includes HSS hostnames. Determining network addresses can permit visited authorization server(s) 118 to communicate with home authorization server(s) 122 to determine whether terminal 102 is permitted to attach to visited network 112 and, if so, what service(s) terminal 102 is permitted to use.

In some examples, terminal 102 communicates with one or more control device(s) 124 of the visited network 112, e.g., an MME or SGSN, in addition to or instead of communicating directly with visited authorization server(s) 118. For example, the control device(s) 124 can communicate with the visited authorization server(s) 118 or home authorization server(s) 122 on behalf of the terminal. An example of such a configuration is the LTE S8-interface home-routed (S8HR) configuration. In this configuration, terminal 102 communicates via an S-GW (access gateway 116) with an MME (control device 124). The MME then communicates with an HSS (home authorization server 122) and establishes General Packet Radio Service (GPRS) Tunneling Protocol (GTP) tunnel(s) 128 (discussed below) through the S-GW to an LTE packet data network (PDN) gateway (P-GW) of home network 114, or to other application servers 106.

Once terminal 102 is authorized by home authorization server(s) 122 and attached to visited network 112, terminal 102 can participate in sessions. For example, terminal 102 can initiate a session with terminal 104 by exchanging messages via signaling path 120 and tunnel 128. For example, terminal 102 can transmit a SIP INVITE message having a Session Description Protocol (SDP) body including a session description, or other session-initiation message. In some examples, the session-initiation message is not associated with a handover. Application server(s) 106 or terminal 104 can, in response, transmit corresponding SIP response(s), e.g., a SIP 180 Ringing or 200 OK response.

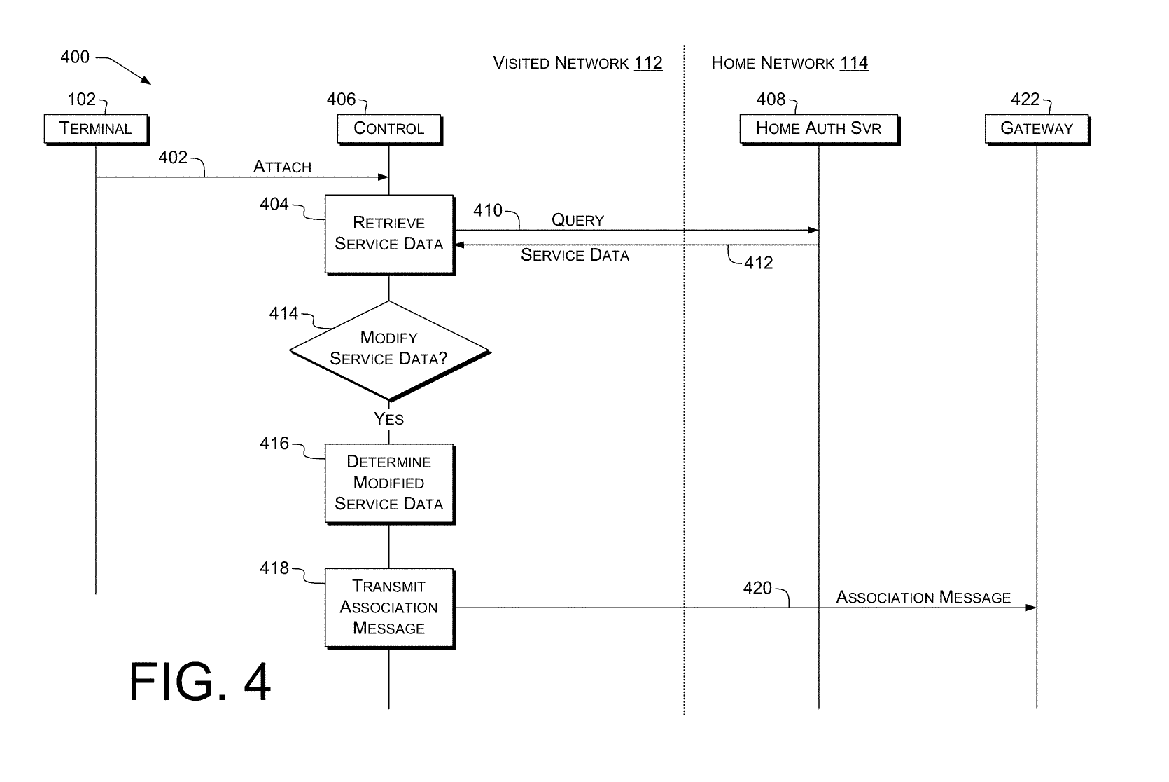

In some examples, e.g., as discussed herein with reference to FIGS. 4-13, visited authorization server(s) 118 or control device(s) 124 perform authorization processing 126. For example, authorization processing 126 can include removing information provided by home authorization server(s) 122 if that information corresponds with a service that terminal 102 is not permitted to access while roaming in visited network 112. In some examples, authorization processing 126 can include establishing at least one tunnel 128 (depicted using the dashed arrow), e.g., a GTP or Proxy Mobile IPv6 (PMIPv6) tunnel. Tunnel 128 can include an association between access gateway 116 and an application server 106 or other network device that permits terminal 102 to communicate with that application server 106. Terminal 102 can then receive network services from application server 106 via tunnel 128. Additionally or alternatively, tunnel 128 can permit communication between terminal 102 and a gateway device such as a P-GW.

As used herein, a message “transmitted to” or “transmitted toward” a destination, or similar terms, can be transmitted directly to the destination, or can be transmitted via one or more intermediate network devices to the destination. In the illustrated example, terminal 102 transmits identification information to visited authorization server 118 via access network 108, including access gateway 116. Similarly, a message “received from” a destination can be received directly from the destination, or can be received via one or more intermediate network devices from the destination. In the illustrated example, terminal 102 can receive information regarding tunnel 128, e.g., an IP address of terminal 102's end of tunnel 128, from visited authorization server 118 via access network 108, including access gateway 116. A message passing through one or more intermediate network devices can be modified by those network devices, e.g., by adding or removing framing, or by changing a presentation of at least part of the message, e.g., from a SIP start-line to a SIP header or vice versa.

Session initiation can be performed, e.g., as defined in the GSM or VoLTE standards, and can include the exchange of additional messages (not shown) between the terminals 102 and 104 and the application server(s) 106. Data of the session, such as audio data or video data, can be exchanged between terminals 102 and 104 via a media path 130. In some examples, media path 130 can pass through or involve access gateway 116, or one or more media gateway(s) 132. Media gateway(s) 132 can be located in visited network 112 or home network 114, in any combination. Signaling path 120 and media path 130 are shown for clarity of explanation. However, in some examples, signaling messages can travel over paths instead of or in addition to signaling path 120, or media messages can travel over paths instead of or in addition to media path 130.

In some examples, the application server(s) 106 can be entirely in visited network 112, entirely in home network 114, or at least one in each network 112, 114. In some examples, the media gateway(s) 132 can be entirely in visited network 112, entirely in home network 114, or at least one in each network 112, 114. This is represented graphically by the placement of application server(s) 106 and media gateway(s) 132 straddling the line between visited network 112 and home network 114. In some examples, each of the application server(s) 106 and media gateway(s) 132 belongs to either the visited network 112 or the home network 114. In some implementations, visited network 112 includes at least one application server 106 or at least one media gateway 132. In some implementations, home network 114 includes at least one application server 106 or at least one media gateway 132.

Various examples herein permit controlling bandwidth usage and network congestion by controlling which services are available to which parties on which networks. Various examples herein permit controlling service access based on, e.g., user, visited network and device type (or any combination of any of those). For example, authentication processing 126 can include modifying service data based on MCC/MNC, roaming/not-roaming, subscriber bandwidth allowances, overall network load, or other factors. In some examples, disallowing PS voice when the voice-grade network is overloaded can permit the overload to clear more quickly, and can improve call quality (e.g., for a 3G call that has ample bandwidth, as compared to a 4G call suffering significant packet loss).

FIG. 2 illustrates an example telecommunications network 200. Terminal 202, which can represent terminal 102 or 104, is roaming in visited network 112 of the telecommunications network 200. In the example of FIG. 2, visited network 112 includes a PS access network 204, e.g., an EPS. Visited network 112 can additionally or alternatively include a CS access network or a LAN access network, e.g., a WIFI access network. Each access network can be configured to selectively carry a communication session of terminal 202.

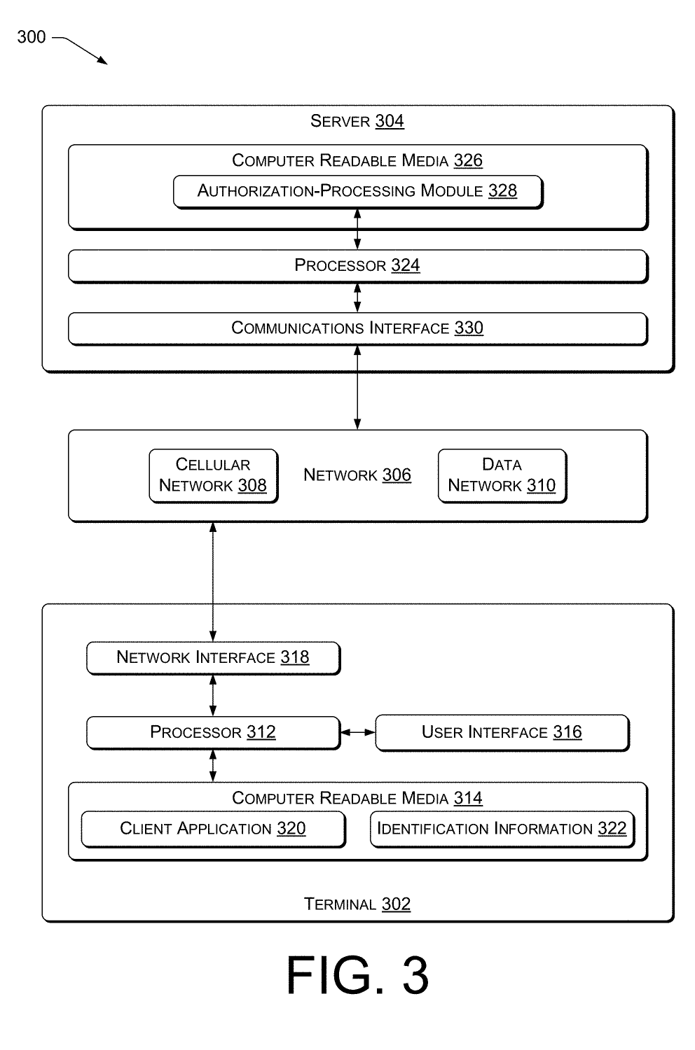

In the illustrated example, the PS access network 204 of visited network 112, e.g., an LTE access network, includes an eNodeB 206, e.g., a 4G base station or other access point, that provides connectivity to the PS access network 204. The eNodeB 206 is connected with a gateway 208, depicted as, but not limited to, an LTE S-GW. PS access network 204 also includes an MME 210 connected with the GW 208, and a DRA 212 connected with the MME 210. MME 210 and DRA 212 can be among, or otherwise represent, visited authorization server(s) 118. In some examples, MME 210 can perform functions described herein with reference to FIG. 3-10 or 14. In some examples, DRA 212 can perform functions described herein with reference to 3 or 11-13.

Visited network 112 is communicatively connected with a home network 114. Home network 114 includes an HLR/HSS 214, which can be among, or otherwise represent, home authorization server(s) 122. Other examples of home authorization server(s) 122 can include, e.g., an equipment identity register (EIR), an enhanced EIR (EEIR), a DNS server, or an E.164 Number Mapping (ENUM) server. In some examples, MME 210 or DRA 212 can communicate with HLR/HSS 214. Communications between a visited authorization server 118 and HLR/HSS 214 can be direct, e.g., MME 210 directly to HLR/HSS 214, or indirect, e.g., via DRA 212 or another relay or agent (omitted for brevity).

GW 208 can communicates with an IMS 216 of the home network 114. For example, gateway 208 can be or include at least one of an S-GW, a P-GW, an Interconnection Border Control Function (IBCF), a Transition Gateway (TrGW), a media gateway (MGW), or another gateway or gateway(s) between visited network 112 and home network 114. IMS 216 can provide media-handling services to terminal 202, e.g., to route video or voice data or to maintain continuity of a communication session during handover of the communication session. IMS 216 can include a number of nodes, such as a proxy call session control function (P-CSCF) 218, a serving call session control function (S-CSCF) 220, and an application server (AS) 222, e.g., a TAS.

In an example of session-control services, a SIP signaling path 224 of the communication session passes through eNodeB 206, GW 208, P-CSCF 218, S-CSCF 220, and AS 222, as indicated by the stippled arrow. After AS 222, the example SIP signaling path passes back through S-CSCF 220 to a peer (not shown). In an example in which terminal 202 is an originating terminal (MO UE), the peer can be, e.g., an S-CSCF corresponding to a terminating terminal (MT UE, omitted for brevity). In the illustrated example, the AS 222 is an anchoring network device and proxies signaling traffic for the communication session, e.g., operating as a SIP proxy or back-to-back user agent (B2BUA).

In some examples, home network 114 includes a home gateway 226, depicted as, but not limited to, a P-GW. In some of these examples, communications between gateway 208 and P-CSCF 218 (or other components of home network 114) pass through home gateway 226 instead of proceeding between gateway 208 and P-CSCF 218, e.g., directly or via other components not shown. In some examples using gateway 226, gateway 208 in the visited network 112 can be an S-GW. In some examples, terminal 202 can access multiple network services, each having its own gateway 226 (e.g., P-GW). In some examples, traffic is carried in tunnel 128, e.g., a GTP or PMIPv6 tunnel, between gateway 208 and gateway 226. Packets can alternatively be carried from gateway 208 to P-CSCF 218 via other core network devices.

The telecommunications network 200 may also include a number of devices or nodes not illustrated in FIG. 2. Such devices or nodes may include an access transfer control function (ATCF), an access transfer gateway (ATGW), a visitor location register (VLR), a serving GPRS support node (SGSN), a gateway GPRS support node (GGSN), a policy control rules function (PCRF) node, or a session border controller (SBC). IMS 216 may further include a number of devices or nodes not illustrated in FIG. 2, such as a presence server and one or more additional CSCFs. A core network of the telecommunications network 200 may be a GPRS core network or an EPC network, or may include elements from both types of core networks. In some examples, control device(s) 124 can include an SGSN.

The telecommunications network 200 may provide a variety of services to terminal 202, such as synchronous communication routing across a PSTN. Further services may include call control, switching, authentication, billing, etc. In at least one example, IMS 216 functions and devices communicate using specific services provided by the visited network 112 or elements thereof, but are not directly tied to those specific services. For example, IMS 216 devices can intercommunicate using an EPC network, a GSM network, a SONET network, or an Ethernet network.

The devices and networks illustrated in FIG. 2 can be examples of the devices and networks illustrated in FIG. 1 and described above. For instance, terminal 202 can represent terminal 102 or 104, application server 222 can represent application server(s) 106, MME 210 can represent control device(s) 124, or DRA 212 can represent authorization server(s) 118. Also, the eNodeB 206 can be an access point for the PS access network 204. A CS base station (not shown) can be a base station for the CS access network. Accordingly, the descriptions of the devices and networks of FIG. 1 apply to the devices and networks of FIG. 2.

FIG. 3 is a block diagram illustrating a system 300 permitting authorization processing with respect to terminals, e.g., roaming terminals, according to some implementations. The system 300 includes a terminal 302, e.g., a wireless phone or other terminal such as terminal 102 or 104, FIG. 1, or terminal 202, FIG. 2, coupled to a server 304 via a network 306. The server 304 can represent a visited authorization server 118, e.g., MME 210 or DRA 212, or other control device or authorization server of a telecommunications network.

The network 306 can include one or more networks, such as a cellular network 308 and a data network 310. The network 306 can include one or more core network(s) connected to terminal(s) via one or more access network(s). Example access networks include LTE, WIFI, GSM Enhanced Data Rates for GSM Evolution (EDGE) Radio Access Network (GERAN), UTRAN, and other cellular access networks. Service access control as described herein can be performed, e.g., for services provided via 2G, 3G, 4G, WIFI, or other networks. Service access control can be performed with respect to any party known to the network, e.g., any party registered in an IMS or having an IMSI or IMEI.

The cellular network 308 can provide wide-area wireless coverage using a technology such as GSM, Code Division Multiple Access (CDMA), UMTS, LTE, or the like. Example networks include Time Division Multiple Access (TDMA), Evolution-Data Optimized (EVDO), Advanced LTE (LTE+), Generic Access Network (GAN), Unlicensed Mobile Access (UMA), Orthogonal Frequency Division Multiple Access (OFDM), GPRS, EDGE, Advanced Mobile Phone System (AMPS), High Speed Packet Access (HSPA), evolved HSPA (HSPA+), VoIP, VoLTE, IEEE 802.1x protocols, wireless microwave access (WIMAX), WIFI, and/or any future IP-based network technology or evolution of an existing IP-based network technology. Communications between the server 304 and terminals such as the terminal 302 can additionally or alternatively be performed using other technologies, such as wired (Plain Old Telephone Service, POTS, or PSTN lines), optical (e.g., Synchronous Optical NETwork, SONET) technologies, and the like.

The data network 310 can include various types of networks for transmitting and receiving data (e.g., data packets), including networks using technologies such as WIFI, IEEE 802.15.1 (“Bluetooth”), Asynchronous Transfer Mode (ATM), WIMAX, and other network technologies, e.g., configured to transport IP packets. In some examples, the server 304 includes or is communicatively connected with an interworking function (IWF) or other device bridging networks, e.g., LTE, 3G, and POTS networks. In some examples, the server 304 can bridge SS7 traffic from the PSTN into the network 306, e.g., permitting PSTN customers to place calls to cellular customers and vice versa.

In some examples, the cellular network 308 and the data network 310 can carry voice or data. For example, the data network 310 can carry voice traffic using Voice over Internet Protocol (VoIP) or other technologies as well as data traffic, or the cellular network 308 can carry data packets using High Speed Packet Access (HSPA), LTE, or other technologies as well as voice traffic. Some cellular networks 308 carry both data and voice in a PS format. For example, many LTE networks carry voice traffic in data packets according to the voice-over-LTE (VoLTE) standard. Various examples herein provide origination and termination of, e.g., carrier-grade voice calls on, e.g., networks 306 using CS transports or mixed VoLTE/3G transports, or on terminals 302 including original equipment manufacturer (OEM) handsets and non-OEM handsets.

The terminal 302 can be or include a wireless phone, a wired phone, a tablet computer, a laptop computer, a wristwatch, or other type of terminal. The terminal 302 can include one or more processors 312, e.g., one or more processor devices such as microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs), and one or more computer readable media (CRM) 314, such as memory (e.g., random access memory (RAM), solid state drives (SSDs), or the like), disk drives (e.g., platter-based hard drives), another type of computer-readable media, or any combination thereof. The terminal 302 can further include a user interface (UI) 316, e.g., including an electronic display device, a speaker, a vibration unit, a touchscreen, or other devices for presenting information to a user and receiving commands from the user. The terminal 302 can further include one or more network interface(s) 318 configured to selectively communicate (wired or wirelessly) via the network 306, e.g., via an access network 108 or 110.

The CRM 314 can be used to store data and to store instructions that are executable by the processors 312 to perform various functions as described herein. The CRM 314 can store various types of instructions and data, such as an operating system, device drivers, etc. The processor-executable instructions can be executed by the processors 312 to perform the various functions described herein.

The CRM 314 can be or include computer-readable storage media. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information and which can be accessed by the processors 312. Tangible computer-readable media can include volatile and nonvolatile, removable and non-removable media implemented in any method or technology for storage of information, such as computer readable instructions, data structures, program modules, or other data.

The CRM 314 can include processor-executable instructions of a client application 320. The client application 320, e.g., a native or other dialer, can permit a user to originate and terminate communication sessions associated with the terminal 302, e.g., a wireless phone. The client application 320 can additionally or alternatively include an SMS, RCS, or presence client, or a client of another telephony service offered by the server 304.

The CRM 314 can store information 322 identifying the terminal 302. The information 322 can include, e.g., an IMEI, an IMSI identifying the subscriber using terminal 302, or other information discussed above. The CRM 314 can additionally or alternatively store credentials (omitted for brevity) used for access, e.g., to IMS or RCS services.

The server 304 can include one or more processors 324 and one or more CRM 326. The CRM 326 can be used to store processor-executable instructions of an authorization-processing module 328. The processor-executable instructions can be executed by the one or more processors 324 to perform various functions described herein, e.g., authorization processing 126. In some examples, server 304 can be configured to, e.g., by executing the processor-executable instructions, perform functions described herein with reference to FIGS. 4-14.

In some examples, server 304 can communicate with (e.g., is communicatively connectable with) terminal 302 or other devices via one or more communications interface(s) 330, e.g., network transceivers for wired or wireless networks, or memory interfaces. Example communications interface(s) 330 can include ETHERNET or FIBRE CHANNEL transceivers, WIFI radios, or DDR memory-bus controllers (e.g., for DMA transfers to a network card installed in a physical server 304).

In some examples, processor 312 and, if required, CRM 314, are referred to for brevity herein as a “control unit.” For example, a control unit can include a CPU or DSP and instructions executable by that CPU or DSP to cause that CPU or DSP to perform functions described herein. Additionally or alternatively, a control unit can include an ASIC, FPGA, or other logic device(s) wired (physically or via blown fuses or logic-cell configuration data) to perform functions described herein. Other examples of control units can include processor 324 and, if required, CRM 326.

### Illustrative Operations

FIG. 4 shows a call flow 400 illustrating an example of modification of service data. In FIG. 4 and other call flows herein, there is shown a non-limiting, example division into systems of visited network 112 and systems of home network 114. Flow 400 is triggered by or commences with an attach message 402 from a terminal, e.g., terminal 102. The attach message can include, e.g., an LTE SlAP Initial UE Message.

At 404, in some examples, the attach message 402 is received by a control device 406, e.g., an MME. Control device 406 retrieves service data associated with the terminal 102 from a home authorization server 408 (“Auth Svr”), e.g., an HSS/HLR. The service data can be associated with terminal 102 directly, e.g., based on the IMEI of terminal 102. Additionally or alternatively, the service data can be directly associated with a mobile subscriber (e.g., a user), identified by an IMSI, and thus also associated with a terminal 102 whose SIM card stores that IMSI.

In some examples, block 404 can include determining identification information of the terminal 102 based on the attach message 402. Block 404 can include transmitting a query message 410, e.g., an LTE Update Location Request (ULR), to home authorization server 408, and receiving the service data via a message 412, e.g., an LTE Update Location Answer (ULA). The service data can include at least one packet data network (PDN) subscription, e.g., expressed as an APN-Configuration Information Element (IE) (see ETSI TS 129 272 v14.3 §§ 7.3.34 and 7.3.35).

At 414, in some examples, control device 406 determines that a portion of the service data corresponds with a predetermined network service, e.g., a service that is not supported by the VPLMN. Control device 406 thus determines that the service data should be modified. Block 414 can additionally or alternatively include determining that the terminal is roaming and determining, at least partly in response, that the service data should be modified.

At 416, in some examples, control device 406 determines modified service data at least party by removing the portion of the service data from the service data or a copy thereof.

At 418, in some examples, control device 406 transmits an association message 420 to a gateway device 422, e.g., a P-GW, on behalf of terminal 102. For example, the association message 420 can initiate setup of a tunnel 128 between terminal 102 and gateway device 422. The association message can be or include, e.g., an LTE Create Session Request (CSR). The gateway device 422 can be a gateway device indicated in the modified service data, e.g., a gateway device providing access to a service that is supported by both the HPLMN and the VPLMN. The gateway device can be identified by an Access Point Name (APN), hostname, network address, or other identifier in the modified service data.

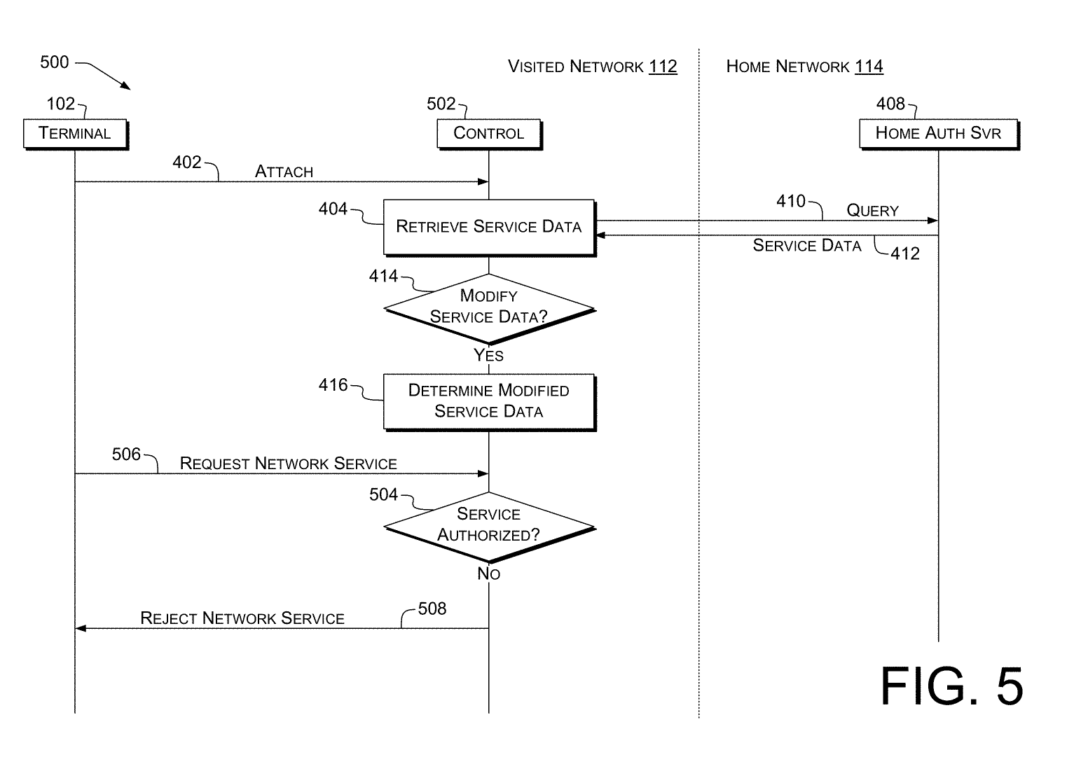

FIG. 5 shows a call flow 500 illustrating an example of modification of service data. This call flow is as shown in FIG. 4 except as noted. As in FIG. 4, the attach message 402 from terminal 102 to control device 502 triggers the flow. Block 404, home authorization server 408, messages 410 and 412, and blocks 414 and 416 can be as in FIG. 4. In some examples, control device implements operations of call flow 400. In some examples, control device implements operations of call flow 500. In some examples, control device implements operations of both call flow 400 and call flow 500.

At 504, in some examples, control device 502 receives a request 506 for network service from terminal 102. Control device 502 determines whether the modified service data from block 416 authorizes the requested service. For example, request 506 can include an APN identifying the requested service. Control device 502 can determine whether the APN is listed in the modified service data. In response to a determination that the modified service data does not authorize the network service identified in request 506, control device 502 can transmit a rejection message 508 to terminal 102 via communications interface 330. In various examples, the service-failure message can include a SIP 488 Not Supported response. The service-failure message can additionally or alternatively include other SIP return codes, e.g., in the 4xx, 5xx, or 6xx series, or other error or warning messages defined in other protocols, e.g., MSRP.

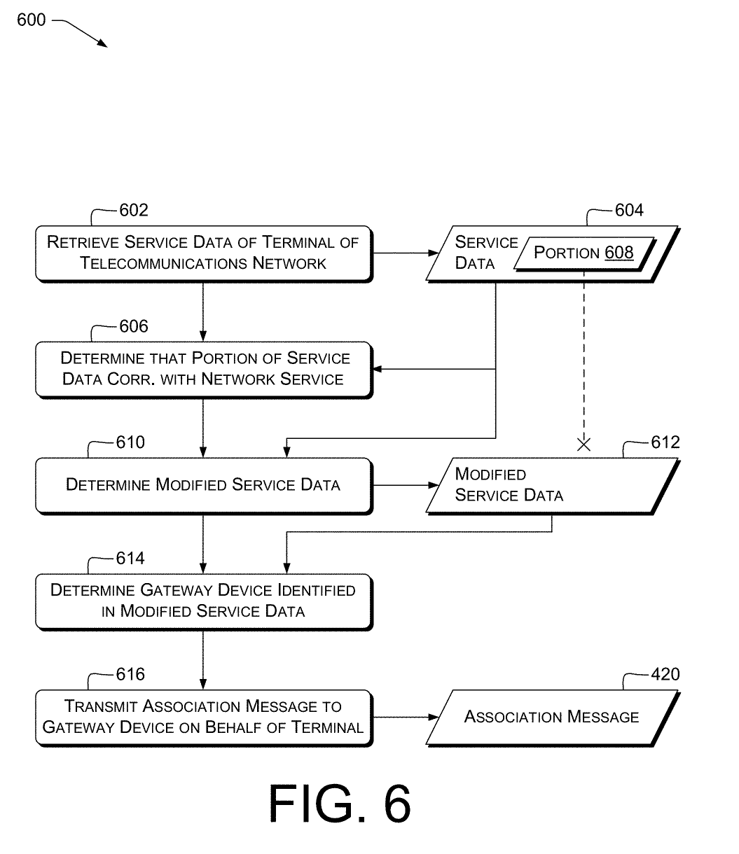

FIG. 6 is a dataflow diagram illustrating an example process 600 for controlling access to network services, and related data items. Process 600 can be performed, e.g., by a control device of a telecommunications network, e.g., the server 304 (for example, an MME). The control device, e.g., control device 406 or 502, can communicate with user equipment, e.g., terminal 102, 302, of a telecommunications network 306. In some examples, the core network device includes one or more processors (e.g., processor 324) configured to perform operations described below, e.g., in response to computer program instructions of the authorization-processing module 328.

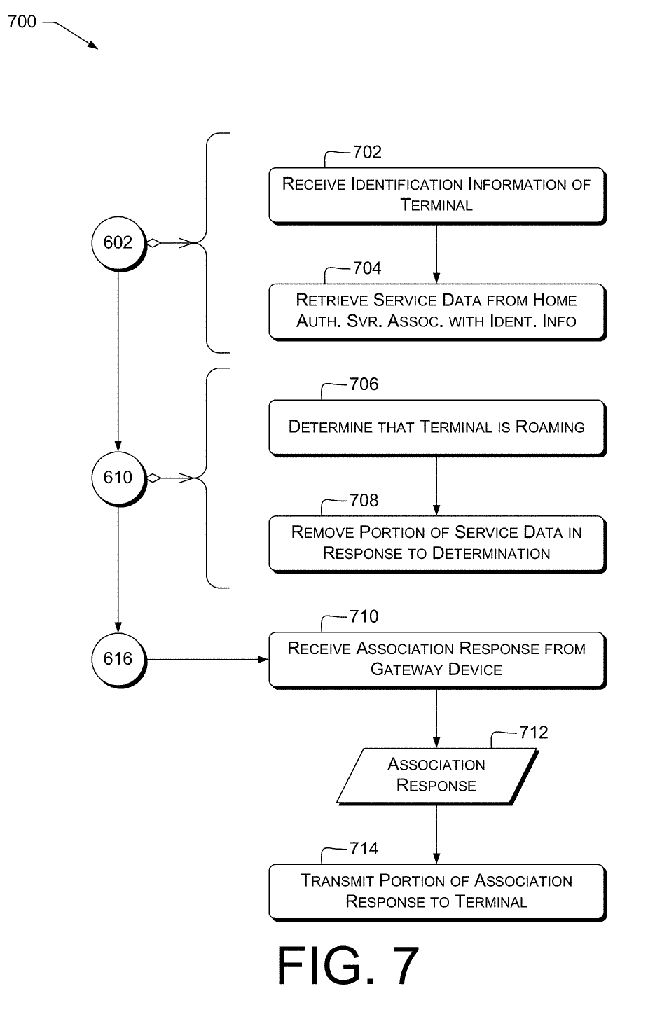

Operations shown in FIG. 6 and in FIGS. 7-10 and 12-14, discussed below, can be performed in any order except when otherwise specified, or when data from an earlier step is used in a later step. For clarity of explanation, reference is herein made to various components shown in FIGS. 1-3 that can carry out or participate in the steps of the exemplary method, and to various operations and messages shown in FIGS. 4 and 5 that can occur while the exemplary method is carried out or as part of the exemplary method. It should be noted, however, that other components can be used; that is, exemplary method(s) shown in FIGS. 6-10 and 12-14 are not limited to being carried out by the identified components, and are not limited to including the identified operations or messages.

At 602, in some examples, the server 304, e.g., the processor 324, retrieves service data 604 of a terminal 102 of the telecommunications network. For example, the server 304 can retrieve the service data the service data from a database. Additionally or alternatively, the server 304 can retrieve the service data 604 from a home authorization server 122, e.g., an HS S/HLR, via communications interface 330. Examples are discussed herein, e.g., with reference to block 404, query 410, e.g., a ULR, and service-data response message 412, e.g., a ULA. Service data 604 can include a profile extracted from the ULA.

At 606, in some examples, the server 304 can determine that a portion 608 of the service data 604 corresponds with a predetermined network service. The predetermined network service can be a service not supported by the network for the particular terminal 102, e.g., a blacklisted service or a service not provided by the VPLMN to roaming terminals 102. The predetermined network service can be identified by, e.g., an APN or port number, and block 606 can include determining that the APN or port number is included in a database or other datastore listing disallowed network services. Examples are discussed herein, e.g., with reference to block 414. In some examples, the predetermined network service comprises a PS media service. For example, the PS media service can include VoLTE.

In some examples, the service data 604 can include a PDN subscription, e.g., expressed in or as a Subscription-Data Diameter attribute-value pair (AVP) in a ULA (ETSI TS 129 272 v14.3 Table 5.2.1.1.1/2). The Subscription-Data AVP can include an APN-Configuration-Profile AVP, which can in turn include one or more APN-Configuration AVPs. Each APN-Configuration AVP can include a Service-Selection AVP indicating an APN with respect to which the home network 114 is willing to provide the terminal 102 with network service. For example, the APN for T-MOBILE LTE data service is “fast.t-mobile.com”. In another example, the well-known APN for VoLTE is “IMS” (GSMA IR.88 v16.0 § 6.3.2).

In some examples, the portion 608 of the service data 604 can include a specific APN-Configuration AVP naming an APN that is not supported by visited network 112. For example, if visited network 112 does not support VoLTE by roaming terminals 102, the portion 608 of the service data 604 can include the APN-Configuration AVP for the “IMS” APN.

At 610, in some examples, the server 304 can determine modified service data 612 at least party by removing the portion 608 of the service data 604, e.g., from the service data 604 or a copy of at least a portion thereof. This is graphically depicted by the dashed line and “X” mark. The server 304 can perform other modifications, or can leave the remainder of the service data 604 unchanged. Block 610 can include removing more than one portion, e.g., in response to the service data 604 including multiple APN-Configurations associated with unsupported network services. Examples are discussed herein, e.g., with reference to block 416.

In some examples, block 606 or 610 can include determining the portion 608 of the service data 604 excluding a flag indicating whether voice sessions are permitted over PS transports. In some prior schemes, the MME can indicate to a terminal 102 that VoLTE is not supported by clearing the IMS voice over PS session indicator (IMS VoPS) in the EPS network feature support information element included in the LTE NAS Attach Accept message (ETSI TS 124 301 v14.4.0 Tables 8.2.1.1 and 9.9.3.12A.1). However, misbehaving roaming terminals 102 may disregard the IMS VoPS flag and attempt to establish VoLTE sessions via a tunnel between the visited S-GW and the home P-GW. In some examples, since the portion 608 does not include an IMS VoPS or other flag indicating whether voice sessions are permitted over PS transports, modifying the service data 604 at block 610 can circumvent such attempts by misbehaving terminals 102.

In some examples, block 606 or 610 can include determining the portion of the service data comprising a service-selection value. For example, the service-selection value can be an APN, an APN network identifier (NI), or another identifier. The service-selection value can be carried in a Diameter Service-Selection AVP (ETSI TS 129 272 v14.3 § 7.3.36) in an APN-Configuration IE, or in another field. This can permit server 304 to control access to services based on their APNs. This can permit controlling access more effectively than by using network addresses or other identifiers that may change over time. This can also permit controlling accesses to services having well-known service-selection values, e.g., the “IMS” well-known APN, without needing to take into account the specific configuration of any particular roaming terminal 102 or home network 114.

At 614, in some examples, server 304 can determine a gateway device 422 identified in the modified service data 612. The gateway device 422 can include, e.g., a P-GW in home network 114, or another gateway. Gateway device 422 corresponds with a service that is supported by both visited network 112 and home network 114, since the corresponding parts of service data 604 were provided by the home authorization server 122 and retained by the visited server 304 at block 610. Examples are discussed herein, e.g., with reference to block 418.

In some examples, as noted above, modified service data 612 includes at least one APN-Configuration IE (ETSI TS 129 272 v14.3 § 7.3.35). The APN-Configuration IE can include a Specific-APN-Info AVP (§ 7.3.82) that itself includes a MIP6-Agent-Info AVP (§ 7.3.45). The MIP6-Agent-Info AVP “contain[s] the identity of the PDN-GW” as “either an IP address . . . or an FQDN” (id.). Block 614 can include parsing or otherwise traversing the modified service data 612 to find the MIP-Home-Agent-Address (IPv4 or IPv6 address) or MIP-Home-Agent-Host (FQDN) field(s), and extracting value(s) of those field(s) as value(s) identifying the determined gateway device 422.

At 616, in some examples, server 304 can transmit, via the communications interface 330, an association message 420 to the gateway device 422 on behalf of the terminal 102. For example, an MME (server 304) can transmit a Create Session Request (CSR) (association message 420) to a P-GW (gateway device 422) via an S-GW (gateway 208). Additionally or alternatively, an SGSN (server 304) can transmit a PDP context request (association message 420) to a GGSN (gateway device 422). Examples are discussed herein, e.g., with reference to block 418. For example, server 304 can exchange IP datagrams with the gateway device 422 identified in the MIP6-Agent-Info AVP via the communications interface 330. In some examples, blocks 614 and 616 can be performed more than once, e.g., for respective APN-Configuration IEs in the modified service data 612. For example, different APNs can be used for general Internet traffic, IMS, secure user-plane location messaging, RCS, or “personal hotspot” (routing WIFI traffic via a cellular connection) traffic.

In the examples described herein, including examples described with reference to FIGS. 1-5 and 7-14, unless otherwise specified, individual items, e.g., physical items or data items, can be provided or operated on by any combination of the described operations. For example, block 606 can be performed with respect to one or more portions 608 of the service data 604, or block 614 can be performed with respect to one or more gateway device(s) 422. Similarly, any operation described herein can produce data not consumed by a subsequent operation.

FIG. 7 is a dataflow diagram illustrating an example process 700 for controlling access to network services, and related data items. Process 700 can be performed, e.g., by a control device, e.g., the server 304, FIG. 2. In some examples, block 602 can include blocks 702 and 704, or block 610 can include blocks 706 and 708, or block 616 can be followed by block 710, or any combination of those.

At 702, in some examples, server 304 can receive, via the communications interface, identification information associated with the terminal 102. The identification information can include, e.g., an IMEI of terminal 102, an IMSI of a subscriber using terminal 102, a Globally Unique Temporary ID (GUTI), a Packet-Temporary Mobile Subscriber Identity (P-TMSI), a Shortened Temporary Mobile Subscriber Identity (S-TMSI), or other identification information, e.g., described herein or listed in ETSI TS 124 301 v14.4 pp. 354-356).

At 704, in some examples, server 304 can retrieve the service data associated with the terminal 102 from the home authorization server 122 associated with the identification information via the communications interface. For example, server 304 can transmit a ULR to the HS S/HLR associated with the identification information. Server 304 can then receive a ULA including a profile associated with the identification information. Examples are discussed herein, e.g., with reference to block 404, query 410, and service data 412.

At 706, in some examples, server 304 can determine that the terminal 102 is roaming. For example, terminal 102 can provide its provisioned IMSI to server 304. The IMSI includes an MCC and an MNC. Server 304 can compare the MCC and MNC in the IMSI to the stored MCC and MNC of the network operating server 304. If either does not match, server 304 can determine that terminal 102 is roaming. Additionally or alternatively, server 304 can query a database of known terminals associated with visited network 112 to determine whether an IMEI of terminal 102 is in the database. Server 304 can determine that terminal 102 is roaming if that IMEI is not in the database.

At 708, in some examples, server 304 can remove the portion 608 of the service data 604 at least partly in response to the determination that the terminal 102 is roaming. This can permit providing full service access to terminals 102 being served by their home networks, while still controlling access by roaming terminals 102.

At 710, in some examples, after transmitting association message 420 at block 616, server 304 can receive an association response 712 from the gateway device 422. For example, the association response 712 can include a Create Session Response message from a P-GW. Association response 712 can be transmitted directly from gateway device 422 to server 304, or via one or more intermediate network devices, e.g., an S-GW of visited network 112.

At 714, in some examples, server 304 can transmit, via the communications interface, at least a portion of the association response 712 to the terminal 102 via the communications interface. For example, the Create Session Response message can include a PDN Address Allocation (PAA) information element specifying a PDN Address for the terminal 102, e.g., an IPv4 or IPv6 address. Server 304 can transmit the PDN Address to the terminal 102. This can permit the terminal 102 to configure itself for communication via the PDN associated with the Create Session Response.

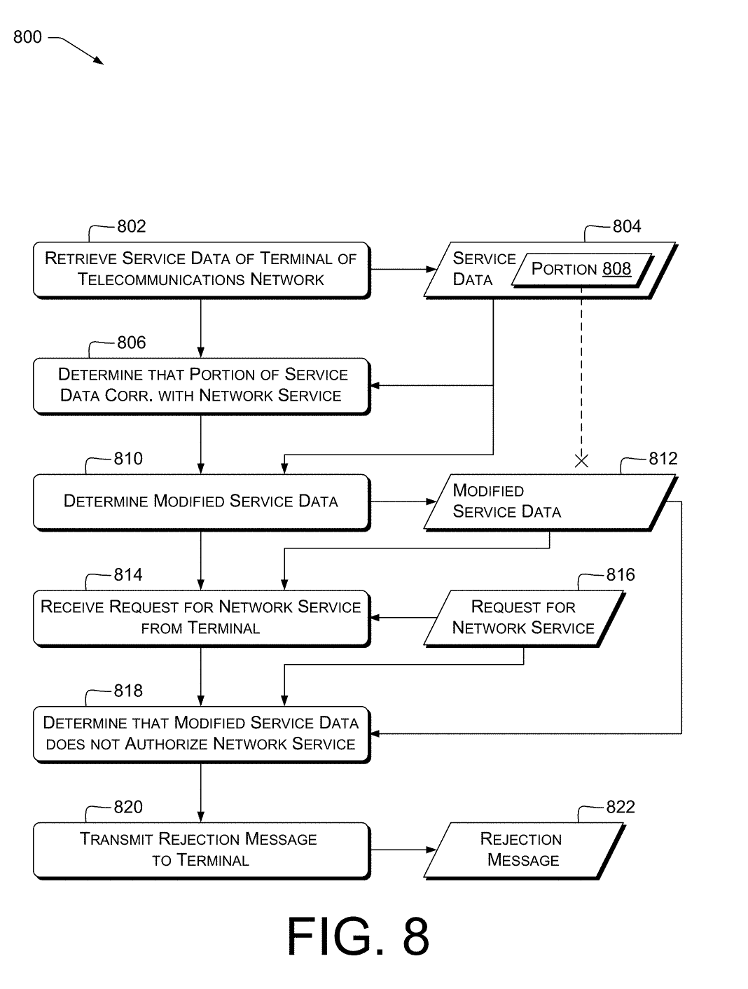

FIG. 8 is a dataflow diagram illustrating an example process 800 for controlling access to network services, and related data items. Process 800 can be performed, e.g., by a control device of a telecommunications network, e.g., the server 304, FIG. 2.

At 802, in some examples, server 304 can retrieve service data 804 of a terminal 102 of the telecommunications network from a home authorization server 122 via a communications interface (e.g., in a ULA from an HSS/HLR or a DRA). Examples are discussed herein, e.g., with reference to block 602.

At 806, in some examples, server 304 can determine that a portion 808 of the service data 804 (e.g., an APN-Configuration AVP) corresponds with a predetermined network service (e.g., a blacklisted APN). Examples are discussed herein, e.g., with reference to block 606. In some examples, as discussed herein with reference to the IMS VoPS flag, block 806 can include determining the portion 808 of the service data 804 excluding a flag indicating whether voice sessions are permitted over PS transports.

At 810, in some examples, server 304 can determine modified service data 812 at least party by removing the portion 808 of the service data 804 from the service data 804 or a copy of at least a portion thereof. Examples are discussed herein, e.g., with reference to block 610.

In some examples, block 806 or 810 can include determining that the terminal 102 is roaming. Examples are discussed herein, e.g., with reference to visited network 112 or block 706. In some examples, block 810 can include removing the portion 808 of the service data 804 at least partly in response to the determination that the terminal 102 is roaming. Examples are discussed herein, e.g., with reference to block 708.

At 814, in some examples, server 304 can receive a request 816 for a network service from the terminal 102. Examples are discussed herein, e.g., with reference to request 506. For example, the request 816 can include a GPRS Activate Secondary PDP Context request, an LTE PDN Connectivity Request (e.g., ETSI TS 123 401 v14.4 § 5.10.2), or another request identifying a network service. Example network services can include, e.g., VoLTE, general data transfer, data transfer with QoS requirements, e.g., for voice or video streams, or discrete message transport (e.g., for SMS).

At 818, in some examples, server 304 can determine that the modified service data 812 does not authorize the network service. This can be done, e.g., by determining that the network service corresponds with the predetermined network service, as discussed herein with reference to block 606. Additionally or alternatively, block 818 can include determining that the network service is not identified in the modified service data 812, e.g., using a database query, string search (e.g., KMP), or other searching or comparison algorithm.

In some examples, the request 816 for the network service includes a service-selection value, e.g., an APN. The modified service data 812 comprises one or more permitted service-selection value, e.g., APNs listed in the user's profile. Block 818 includes determining that the one or more permitted service-selection values do not include the service-selection value. Examples are discussed herein, e.g., with reference to blocks 606 and 610.

At 820, in some examples, server 304 can transmit, via the communications interface, a rejection message 822 to the terminal 102. Examples are discussed herein, e.g., with reference to rejection message 508. For example, the rejection message can include a PDN Connectivity Reject message from the MME to the eNodeB or the terminal 102 (e.g., ETSI TS 124 301 v14.4 § 6.5.1.4). In some examples, the rejection message can include a rejection reason, e.g., LTE code #27 “Missing or unknown APN.” Evaluating the request for network service against the modified service data 812 can permit controlling access to services even when misbehaving terminals 102 disregard other access-control information (e.g., VoPS flag), as discussed above.

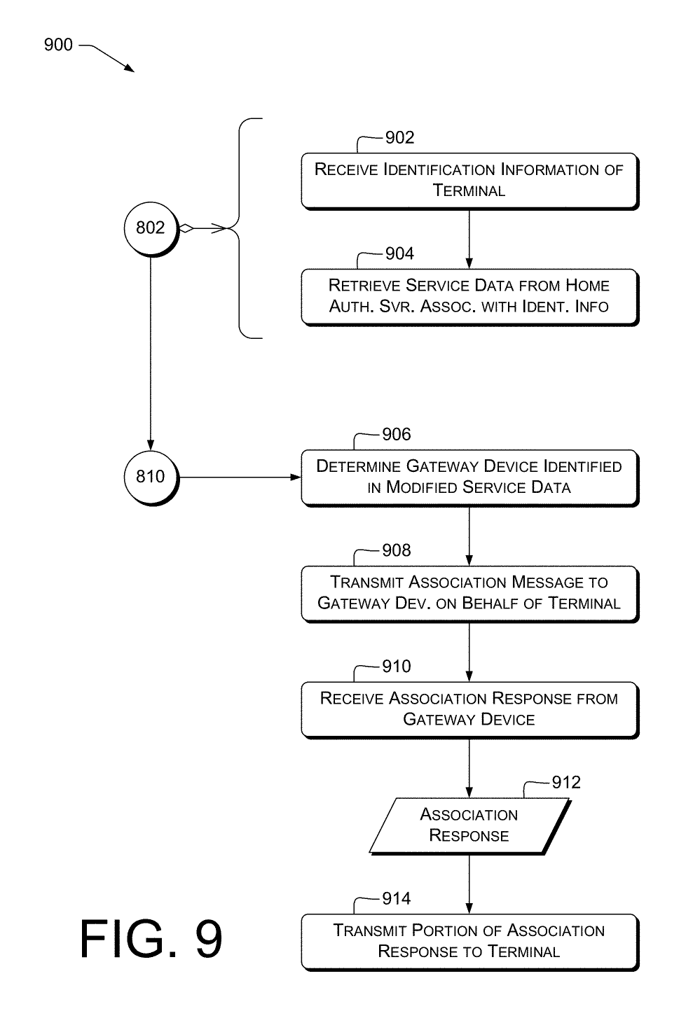

FIG. 9 is a dataflow diagram illustrating an example process 900 for controlling access to network services, and related data items. Process 900 can be performed, e.g., by a control device, e.g., the server 304, FIG. 2. In some examples, block 802 can include blocks 902 and 904, or block 810 can be followed by block 906, or any combination of those.

At 902, in some examples, server 304 can receive, via the communications interface, identification information (e.g., an IMSI) associated with the terminal 102. Examples are discussed herein, e.g., with reference to block 702.

At 904, in some examples, server 304 can retrieve the service data associated with the terminal 102 from the home authorization server associated with the identification information via the communications interface. Examples are discussed herein, e.g., with reference to block 704.

At 906, in some examples, server 304 can determine a gateway device 422, e.g., a P-GW, identified in the modified service data. Examples are discussed herein, e.g., with reference to block 614. Server 304 can determine the gateway device 422 before, after, or concurrently with receiving or processing a request for network service (blocks 814, 818, or 820).

At 908, in some examples, server 304 can transmit, via the communications interface, an association message, e.g., a Create Session Request, to the gateway device 422 on behalf of the terminal 102. Examples are discussed herein, e.g., with reference to block 616.

At 910, in some examples, following block 908, server 304 can receive an association response 912, e.g., a Create Session Response, from the gateway device 422. Examples are discussed herein, e.g., with reference to block 710.

At 914, in some examples, server 304 can transmit at least a portion of the association response 912 to the terminal 102 via the communications interface. Examples are discussed herein, e.g., with reference to block 714.

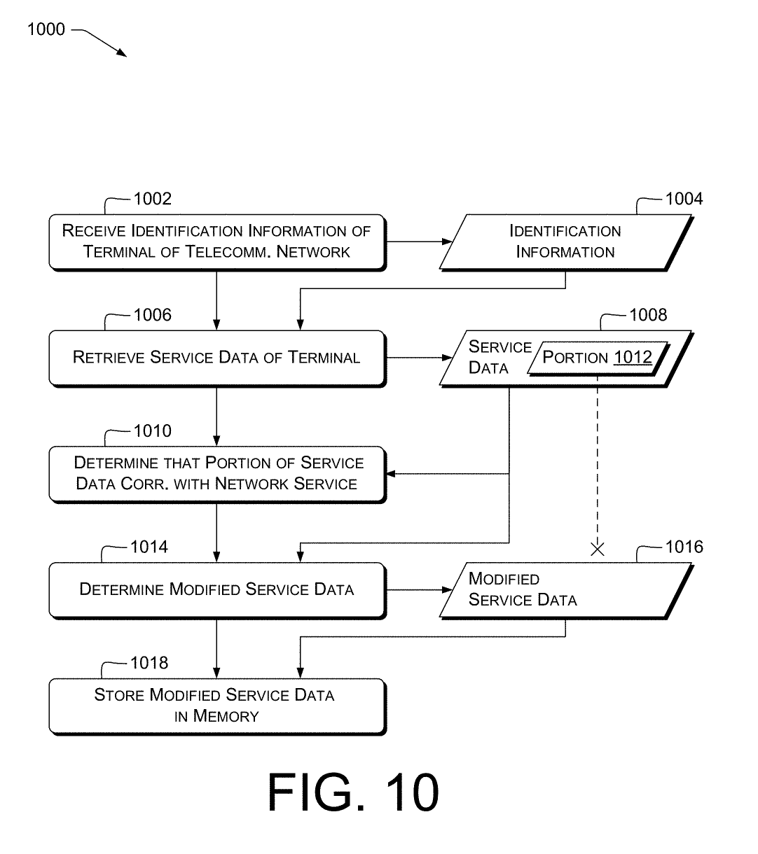

FIG. 10 is a dataflow diagram illustrating an example process 1000 for controlling access to network services, and related data items. Process 1000 can be performed, e.g., by a control device, e.g., the server 304, FIG. 2. For example, a control unit of server 304 or another control device can be configured to perform operations of process 1000.

At 1002, in some examples, server 304 can receive, from the terminal 102 via the communications interface 330, identification information 1004, e.g., an IMSI. Examples are discussed herein, e.g., with reference to block 702.

At 1006, in some examples, server 304 can retrieve service data 1008 of the terminal 102 from a home authorization server 122 associated with the identification information 1004 via the communications interface 330. Examples are discussed herein, e.g., with reference to blocks 602 or 704.

At 1010, in some examples, server 304 can determine that a portion 1012 of the service data 1008 corresponds with a predetermined network service. Examples are discussed herein, e.g., with reference to blocks 610, 706, or 708. In some examples, as discussed above, server 304 can determine the portion 1012 of the service data 1008 excluding a flag indicating whether voice sessions are permitted over PS transports.

At 1014, in some examples, server 304 can determine modified service data 1016 at least party by removing the portion 1012 of the service data 1008. Examples are discussed herein, e.g., with reference to blocks 610 or 708. In some examples, block 1014 can include blocks 706 or 708.

At 1018, in some examples, server 304 can store the modified service data 1016 in a memory, e.g., a RAM, PROM, Flash, or other CRM 326. Storing the modified service data 1016 in the memory can permit responding to requests from terminal 102 at a later time. In some examples, block 1018 can include storing the modified service data 1016 in a buffer for transmission to an MME or other control device(s) 124.

In some examples, block 1018 is followed by blocks 614 and 616; by blocks 614, 616, 710, and 714; by blocks 814, 818, and 820; by blocks 906, 908, 910, and 914, or by any combination of those groups of blocks. In this way, server 304 can, e.g., transmit association message(s) to gateway device(s) identified in the stored modified service data 1016; receive requests for network service and transmit rejection messages for services not authorized by the stored modified service data 1016; remove service data for roaming terminals 102; or perform other functions described above with reference to FIGS. 6-9.

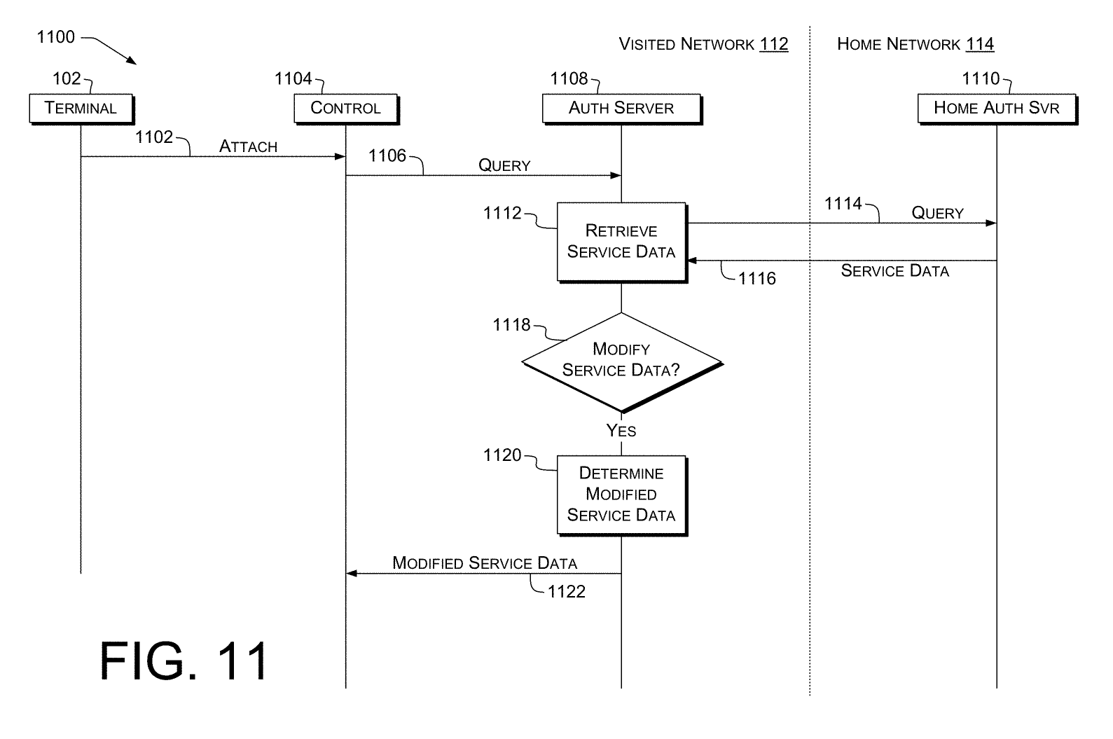

FIG. 11 shows a call flow 1100 illustrating an example of modification of service data. Flow 1100 is triggered by or commences with an attach message 1102 from a terminal, e.g., terminal 102. Examples are discussed herein, e.g., with reference to attach message 402.

Control device 1104, e.g., an MME or other server 304, receives the attach message 1102 and transmits a query 1106 to an authorization server 1108, e.g., of the visited network 112. Authorization server 1108, which can represent server 304, can be or include, e.g., a DRA or other Diameter proxy or agent device, or other network device permitting control device 1104 to communicate with a home authorization server 1110.

At 1112, in some examples, authorization server 1108 can retrieve service data associated with terminal 102 from home authorization server 1110. For example, server 304 can transmit a query 1114, e.g., a ULR, and receive a reply message 1116, e.g., a ULA, including the service data. Examples are discussed herein, e.g., with reference to block 404.

At 1118, in some examples, authorization server 1108 can determine that the service data should be modified. For example, authorization server 1108 can determine that a portion of the service data corresponds with a predetermined network service. Examples are discussed herein, e.g., with reference to block 414.

At 1120, authorization server 1108 can determine modified service data at least party by removing the portion of the service data from the service data or a copy thereof. Examples are discussed herein, e.g., with reference to block 416. Authorization server 1108 can then transmit the modified service data to the control device 1104, e.g., via communications interface 330. This is shown as reply message 1122 carrying the modified service data. Examples are discussed herein, e.g., with reference to blocks 416 and 610.

Modifying service data at authorization server 1108 instead of (or in addition to) at control device 1104 can reduce the complexity of control device 1104. Modifying service data at authorization server 1108 can additionally or alternatively permit updating permitted services by changing configuration data at a relatively smaller number of authorization servers 1108 rather than at a relatively larger number of control devices 1104.

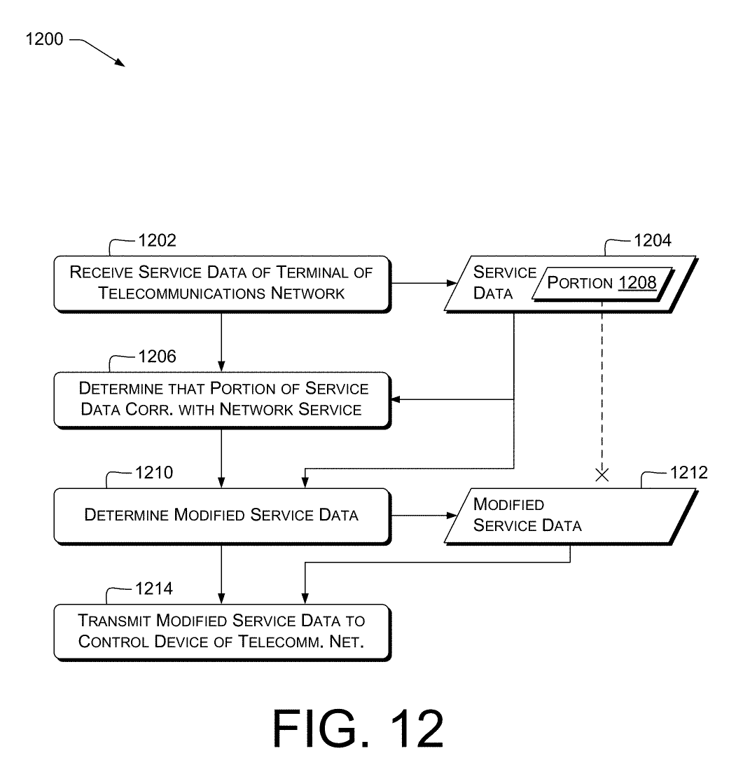

FIG. 12 is a dataflow diagram illustrating an example process 1200 for controlling access to network services, and related data items. Process 1200 can be performed, e.g., by an authorization server of a telecommunications network, e.g., the server 304 (for example, a DRA). The authorization server, e.g., authorization server 1108, can communicate with control devices 1104 or home authorization servers 1110. In some examples, the authorization server 1108 includes one or more processors (e.g., processor 324) configured to perform operations described below, e.g., in response to computer program instructions of the authorization-processing module 328.

At 1202, in some examples, server 304 can receive service data 1204 associated with a terminal 102 of the telecommunications network from a home authorization server 122 via a communications interface 330. Examples are discussed herein, e.g., with reference to block 704 or reply message 1116.

At 1206, in some examples, server 304 can determine that a portion 1208 of the service data 1204 corresponds with a predetermined network service. Examples are discussed herein, e.g., with reference to blocks 414 and 606. For example, server 304 can locate an APN-Configuration IE having a Service-Selection value naming an APN that is not supported by visited network 112. In some examples, the predetermined network service comprises a PS media service. In some examples, e.g., in which the authorization server comprises a Diameter Routing Agent (DRA), the PS media service is or comprises VoLTE.

At 1210, in some examples, server 304 can determine modified service data 1212 at least party by removing the portion 1208 of the service data 1204 from the service data 1204 or a copy thereof. Examples are discussed herein, e.g., with reference to blocks 416, 610, 706, or 708.

In some examples, at block 1206 or 1210, server 304 can determine the portion of the service data excluding a flag indicating whether voice sessions are permitted over PS transports, e.g., the IMS VoPS flag. Examples are discussed herein, e.g., with reference to block 610. Additionally or alternatively, at block 1206 or 1210, server 304 can determine the portion of the service data comprising a service-selection value, e.g., an APN. Examples are discussed herein, e.g., with reference to block 610.

At 1214, in some examples, server 304 can transmit, via the communications interface, the modified service data 1212 to a control device 1104 of the telecommunications network. For example, server 304 can transmit an Update Location Answer including the modified service data 1212. Examples are discussed herein, e.g., with reference to reply message 1122. For example, block 1214 can include transmitting the data that is received by a control device 124 as described with reference to blocks 704 or 904.

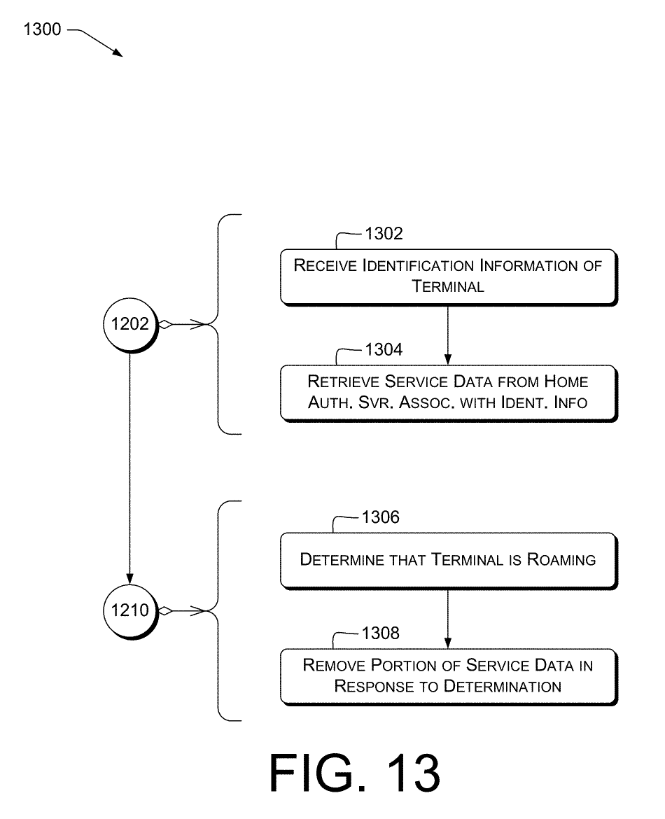

FIG. 13 is a dataflow diagram illustrating an example process 1300 for controlling access to network services, and related data items. Process 1300 can be performed, e.g., by an authorization server, e.g., the server 304, FIG. 2. In some examples, block 1202 can include blocks 1302 and 1304, or block 1210 can include blocks 1306 and 1308, or any combination of those.

At 1302, in some examples, server 304 can receive, via the communications interface, identification information associated with the terminal 102, e.g., an IMSI. Examples are discussed herein, e.g., with reference to blocks 404, 602, or 702.

At 1304, in some examples, server 304 can retrieve, via the communications interface, the service data associated with the terminal 102 from the home authorization server 122 that is associated with the identification information. Examples are discussed herein, e.g., with reference to blocks 404, 602, 702, or 1112.

At 1306, in some examples, server 304 can determine that the terminal is roaming, e.g., by comparing MCC and MNC values associated with the terminal 102 to MCC and MNC values associated with the visited network 112 or authorization server 1108. Examples are discussed herein, e.g., with reference to block 706.

At 1308, in some examples, server 304 can remove the portion of the service data at least partly in response to the determination that the terminal is roaming. Examples are discussed herein, e.g., with reference to block 708.

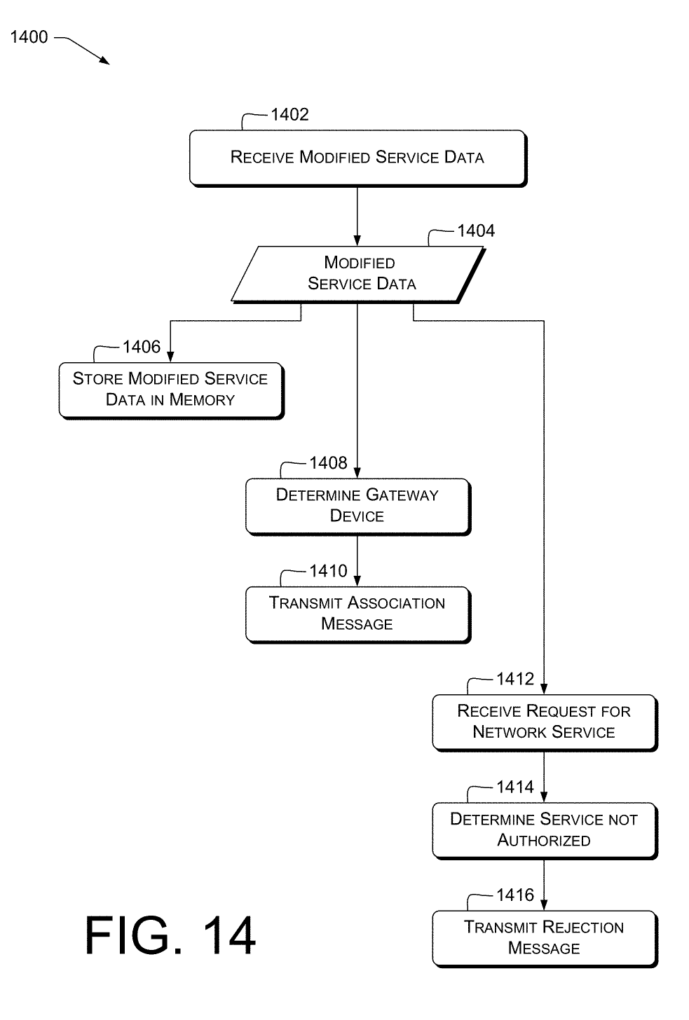

FIG. 14 is a dataflow diagram illustrating an example process 1400 for controlling access to network services, and related data items. Process 1400 can be performed, e.g., by a control device, e.g., the server 304, FIG. 2. For example, a control unit of server 304 or another control device can be configured to perform operations of process 1400. Process 1400 can be used in a system including an authorization server 118 configured to carry out process 1200 and a control device 124 configured to carry out operations of any of the options described with reference to process 1400.

In some examples, process 1400 includes at least, or only, blocks 1402 and 1406 (referred to in this paragraph as “Option A”). In some examples, process 1400 includes at least, or only, blocks 1402, 1408, and 1410 (“Option B”). In some examples, process 1400 includes at least, or only, blocks 1402, 1412, 1414, and 1416 (“Option C”). In some examples, process 1400 includes at least, or only, one of the following combinations: Options A and B, Options B and C, or Options A and C. In some examples, process 1400 includes at least, or only, the combination of Options A, B, and C.

At 1402, in some examples, server 304 can receive modified service data 1404, e.g., from a visited authorization server 118. Modified service data 1404 can represent modified service data 612, 812, or 1016; the modified service data in reply message 1122; or modified service data 1212. The modified service data 1404 can be associated with a terminal 102. Examples are discussed herein, e.g., with reference to blocks 404 or 602, or reply message 1122, e.g., a ULA. The reply message 1122 can be provided by a DRA or other authorization server 118 that has modified the service data as discussed herein with reference to, e.g., FIG. 12 or 13. Block 1402 can be followed by any, or any combination (series or parallel), of blocks 1406, 1408-1410, or 1412-1416.

At 1406, in some examples, server 304 can store the modified service data 1404 in a memory, e.g., CRM 326. Examples are discussed herein, e.g., with reference to block 1018.

At 1408, in some examples, server 304 can determine a gateway device 422, e.g., a P-GW, identified in the modified service data. Examples are discussed herein, e.g., with reference to block 614. For example, server 304 can locate in the modified service data 1404 a MIP6-Agent-Info AVP holding an address or hostname of the gateway device 422.

At 1410, in some examples, server 304 can transmit, via the communications interface 330, an association message to the gateway device 422 on behalf of the terminal. Examples are discussed herein, e.g., with reference to blocks 418 and 616.

At 1412, in some examples, server 304 can receive a request for a network service from the terminal. The request can include, e.g., a PDN Connectivity Request. Examples are discussed herein, e.g., with reference to block 504, request 506, or block 814.

At 1414, in some examples, server 304 can determine that the modified service data does not authorize the network service. Examples are discussed herein, e.g., with reference to blocks 504 or 818.

At 1416, in some examples, server 304 can transmit, via the communications interface, a rejection message to the terminal, e.g., a PDN Connectivity Reject. Examples are discussed herein, e.g., with reference to rejection message 508 and block 820.

### Further Illustrative Configurations

As discussed above, in some examples, a system can include an authorization server 118 and a control device 124 of a telecommunications network. In some examples, authorization server 118 can be configured to perform functions described herein with reference to blocks 1202, 1206, 1210, and 1214, and control device 124 can be configured to perform functions described herein with reference to blocks 1402, 1406, 1408, 1410, 1412, 1414, or 1416.

In some examples, authorization server 118 can be configured to carry out process 1200, and control device 124 can be configured to carry out blocks 1402, 1408, and 1410. Authorization server 118 can further be configured to carry out blocks 1302 and 1304. Authorization server 118 can further be configured to carry out blocks 1306 and 1308. Control device 124 can further be configured to carry out blocks 710 and 714.

In some examples, authorization server 118 can be configured to carry out process 1200, and control device 124 can be configured to carry out blocks 1402, 1412, 1414, and 1416. Authorization server 118 can further be configured to carry out blocks 1302 and 1304. Authorization server 118 can further be configured to carry out blocks 1306 and 1308. Control device 124 can further be configured to carry out blocks 614, 616, 710 and 714.

### Example Clauses

Various examples include one or more of, including any combination of any number of, the following example features. Throughout these clauses, parenthetical remarks are for example and explanation, and are not limiting. Parenthetical remarks given in this Example Clauses section with respect to specific language apply to corresponding language throughout this section, unless otherwise indicated.

A: A method comprising, by a control device of a telecommunications network: retrieving service data associated with a terminal of the telecommunications network from a home authorization server via a communications interface; determining that a portion of the service data corresponds with a predetermined network service; determining modified service data at least party by removing the portion of the service data; determining a gateway device identified in the modified service data; and transmitting, via the communications interface, an association message to the gateway device on behalf of the terminal.

B: The method according to paragraph A, further comprising, by the control device: receiving an association response from the gateway device; and transmitting at least a portion of the association response to the terminal via the communications interface.

C: The method according to paragraph A or B, further comprising, by the control device: determining that the terminal is roaming; and removing the portion of the service data at least partly in response to the determination that the terminal is roaming.

D: The method according to any of paragraphs A-C, further comprising determining the portion of the service data excluding a flag indicating whether voice sessions are permitted over packet-switched transports.

E: The method according to any of paragraphs A-D, further comprising determining the portion of the service data comprising a service-selection value.

F: The method according to any of paragraphs A-E, further comprising, by the control device: receiving, via the communications interface, identification information associated with the terminal; and retrieving the service data associated with the terminal from the home authorization server associated with the identification information via the communications interface.

G: The method according to any of paragraphs A-F, wherein the predetermined network service comprises a packet-switched media service.

H: The method according to paragraph G, wherein the packet-switched media service comprises Voice over Long-Term Evolution (VoLTE) and the control device comprises a Mobility Management Entity (MME).

I: A method comprising, by a control device of a telecommunications network: retrieving service data associated with a terminal of the telecommunications network from a home authorization server via a communications interface; determining that a portion of the service data corresponds with a predetermined network service; determining modified service data at least party by removing the portion of the service data; receiving a request for a network service from the terminal; determining that the modified service data does not authorize the network service; and transmitting, via the communications interface, a rejection message to the terminal.

J: The method according to paragraph I, wherein: the request for the network service includes a service-selection value; the modified service data comprises one or more permitted service-selection values; and the determining that the modified service data does not authorize the network service comprises determining that the one or more permitted service-selection values do not include the service-selection value.

K: The method according to paragraph I or J, further comprising, by the control device: determining that the terminal is roaming; and removing the portion of the service data at least partly in response to the determination that the terminal is roaming.

L: The method according to any of paragraphs I-K, further comprising determining the portion of the service data excluding a flag indicating whether voice sessions are permitted over packet-switched transports.

M: The method according to any of paragraphs I-L, further comprising, by the control device: receiving, via the communications interface, identification information associated with the terminal; and retrieving the service data associated with the terminal from the home authorization server associated with the identification information via the communications interface.

N: The method according to any of paragraphs I-M, further comprising, by the control device: determining a gateway device identified in the modified service data; and transmitting, via the communications interface, an association message to the gateway device on behalf of the terminal.

O: The method according to paragraph N, further comprising, by the control device: receiving an association response from the gateway device; and transmitting at least a portion of the association response to the terminal via the communications interface.

P: A control device of a telecommunications network, the control device comprising: a memory; a communications interface communicatively connectable with a terminal of the telecommunications network; and a control unit communicatively connected with the communications interface and configured to: receive, from the terminal via the communications interface, identification information; retrieve service data associated with the terminal from a home authorization server associated with the identification information via the communications interface; determine that a portion of the service data corresponds with a predetermined network service; determine modified service data at least party by removing the portion of the service data; and store the modified service data in the memory.

Q: The control device according to paragraph P, the control unit further configured to: determine a gateway device identified in the modified service data; and transmit, via the communications interface, an association message to the gateway device on behalf of the terminal.

R: The control device according to paragraph P or Q, the control unit further configured to: receive a request for a network service from the terminal; determine that the modified service data does not authorize the network service; and transmit, via the communications interface, a rejection message to the terminal.

S: The control device according to any of paragraphs P-R, the control unit further configured to: determine that the terminal is roaming in a network associated with the control device; and remove the portion of the service data at least partly in response to the determination that the terminal is roaming.

T: The control device according to any of paragraphs P-S, the control unit further configured to determine the portion of the service data excluding a flag indicating whether voice sessions are permitted over packet-switched transports.

U: A method comprising, by an authorization server of a telecommunications network: receiving service data associated with a terminal of the telecommunications network from a home authorization server via a communications interface; determining that a portion of the service data corresponds with a predetermined network service; determining modified service data at least party by removing the portion of the service data; and transmitting, via the communications interface, the modified service data to a control device of the telecommunications network.

V: The method according to paragraph U, further comprising, by the authorization server: determining that the terminal is roaming; and removing the portion of the service data at least partly in response to the determination that the terminal is roaming.

W: The method according to paragraph U or V, further comprising, by the authorization server, determining the portion of the service data excluding a flag indicating whether voice sessions are permitted over packet-switched transports.

X: The method according to any of paragraphs U-W, further comprising, by the authorization server, determining the portion of the service data comprising a service-selection value.

Y: The method according to any of paragraphs U-X, further comprising, by the authorization server: receiving, via the communications interface, identification information associated with the terminal; and retrieving the service data associated with the terminal from the home authorization server associated with the identification information via the communications interface.

Z: The method according to any of paragraphs U-Y, wherein the predetermined network service comprises a packet-switched media service.

AA: The method according to paragraph Z, wherein the packet-switched media service comprises Voice over Long-Term Evolution (VoLTE) and the authorization server comprises a Diameter Routing Agent (DRA).

AB: A system, comprising: an authorization server of a telecommunications network, the authorization server configured to: receive service data associated with a terminal of the telecommunications network from a home authorization server via a communications interface; determine that a portion of the service data corresponds with a predetermined network service; determine modified service data at least party by removing the portion of the service data; and transmit, via the communications interface, the modified service data to a control device of the telecommunications network; a control device of a telecommunications network, the control device configured to: receive the modified service data; determine a gateway device identified in the modified service data; and transmit, via the communications interface, an association message to the gateway device on behalf of the terminal.

AC: The system according to paragraph AB, the authorization server further configured to: determine that the terminal is roaming; and remove the portion of the service data at least partly in response to the determination that the terminal is roaming.

AD: The system according to paragraph AB or AC, the authorization server further configured to determine the portion of the service data excluding a flag indicating whether voice sessions are permitted over packet-switched transports.

AE: The system according to any of paragraphs AB-AD, the authorization server further configured to determine the portion of the service data comprising a service-selection value.

AF: The system according to any of paragraphs AB-AE, the authorization server further configured to: receive, via the communications interface, identification information associated with the terminal; and retrieve the service data associated with the terminal from the home authorization server associated with the identification information via the communications interface.

AG: The system according to any of paragraphs AB-AF, the control device further configured to: receive an association response from the gateway device; and transmit at least a portion of the association response to the terminal via the communications interface.

AH: A system, comprising: an authorization server of a telecommunications network, the authorization server configured to: receive service data associated with a terminal of the telecommunications network from a home authorization server via a communications interface; determine that a portion of the service data corresponds with a predetermined network service; determine modified service data at least party by removing the portion of the service data; and transmit, via the communications interface, the modified service data to a control device of the telecommunications network; a control device of a telecommunications network, the control device configured to: receive the modified service data; receive a request for a network service from the terminal; determine that the modified service data does not authorize the network service; and transmit, via the communications interface, a rejection message to the terminal.

AI: The system according to paragraph AH, the authorization server further configured to: determine that the terminal is roaming; and remove the portion of the service data at least partly in response to the determination that the terminal is roaming.

AJ: The system according to paragraph AH or AI, the authorization server further configured to determine the portion of the service data excluding a flag indicating whether voice sessions are permitted over packet-switched transports.

AK: The system according to any of paragraphs AH-AJ, the authorization server further configured to determine the portion of the service data comprising a service-selection value.

AL: The system according to any of paragraphs AH-AK, the authorization server further configured to: receive, via the communications interface, identification information associated with the terminal; and retrieve the service data associated with the terminal from the home authorization server associated with the identification information via the communications interface.

AM: The system according to any of paragraphs AH-AL, wherein: the request for the network service includes a service-selection value; the modified service data comprises one or more permitted service-selection values; and the determining that the modified service data does not authorize the network service comprises determining that the one or more permitted service-selection values do not include the service-selection value.

AN: The system according to any of paragraphs AH-AM, wherein the predetermined network service comprises Voice over Long-Term Evolution (VoLTE) and the control device comprises a Mobility Management Entity (MME).

AO: A computer-readable medium, e.g., a computer storage medium, having thereon computer-executable instructions, the computer-executable instructions upon execution configuring a computer to perform operations as any of paragraphs A-H, I-O, or P-T recites.

AP: A device comprising: a processor; and a computer-readable medium, e.g., a computer storage medium, having thereon computer-executable instructions, the computer-executable instructions upon execution by the processor configuring the device to perform operations as any of paragraphs A-H, I-O, or P-T recites.

AQ: A system comprising: means for processing; and means for storing having thereon computer-executable instructions, the computer-executable instructions including means to configure the system to carry out a method as any of paragraphs A-H, I-O, or P-T recites.

AR: A computer-readable medium, e.g., a computer storage medium, having thereon computer-executable instructions, the computer-executable instructions upon execution configuring a computer to perform operations as any of paragraphs U-AA, AB-AG, or AH-AN recites.

AS: A device comprising: a processor; and a computer-readable medium, e.g., a computer storage medium, having thereon computer-executable instructions, the computer-executable instructions upon execution by the processor configuring the device to perform operations as any of paragraphs U-AA, AB-AG, or AH-AN recites.

AT: A system comprising: means for processing; and means for storing having thereon computer-executable instructions, the computer-executable instructions including means to configure the system to carry out a method as any of paragraphs U-AA, AB-AG, or AH-AN recites.

### CONCLUSION

Various aspects described above permit allowing or disallowing access by a terminal to network services, e.g., based on whether the serving network supports those services. For example, service access can be controlled based on whether or not a terminal is roaming in a visited network. In some examples, the home network can support IMS or other services such as VoLTE calling, RCS, SMS over IP, or Presence. In some examples, access to some of these services may be restricted on visited networks. For example, access may be restricted based on the operator of the visited network, a combination of the operator and the user of the terminal, or a combination of the operator, the user, and the requested service. As discussed above, technical effects of various examples can include controlling bandwidth usage, reducing network load, and increasing network reliability.

Example components and data transmissions in FIGS. 1-3, example data exchanges in the call flow diagrams of FIGS. 4, 5, and 11, and example blocks in the process diagrams of FIGS. 6-10 and 12-14 represent one or more operations that can be implemented in hardware, software, or a combination thereof to transmit or receive described data or conduct described exchanges. In the context of software, the illustrated blocks and exchanges represent computer-executable instructions that, when executed by one or more processors, cause the processors to transmit or receive the recited data. Generally, computer-executable instructions, e.g., stored in program modules that define operating logic, include routines, programs, objects, modules, components, data structures, and the like that perform particular functions or implement particular abstract data types. Except as expressly set forth herein, the order in which the transmissions or operations are described is not intended to be construed as a limitation, and any number of the described transmissions or operations can be combined in any order and/or in parallel to implement the processes. Moreover, structures or operations described with respect to a single server or device can be performed by each of multiple devices, independently or in a coordinated manner, except as expressly set forth herein.

Other architectures can be used to implement the described functionality, and are intended to be within the scope of this disclosure. Furthermore, although specific distributions of responsibilities are defined above for purposes of discussion, the various functions and responsibilities might be distributed and divided in different ways, depending on particular circumstances. Similarly, software can be stored and distributed in various ways and using different means, and the particular software storage and execution configurations described above can be varied in many different ways. Thus, software implementing the techniques described above can be distributed on various types of computer-readable media, not limited to the forms of memory that are specifically described.

The word “or” and the phrase “and/or” are used herein in an inclusive sense unless specifically stated otherwise. Accordingly, conjunctive language such as, but not limited to, at least one of the phrases “X, Y, or Z,” “at least X, Y, or Z,” “at least one of X, Y or Z,” “one or more of X, Y, or Z,” and/or any of those phrases with “and/or” substituted for “or,” unless specifically stated otherwise, is to be understood as signifying that an item, term, etc. can be either X, or Y, or Z, or a combination of any elements thereof (e.g., a combination of XY, XZ, YZ, and/or XYZ). Any use herein of phrases such as “X, or Y, or both” or “X, or Y, or combinations thereof” is for clarity of explanation and does not imply that language such as “X or Y” excludes the possibility of both X and Y, unless such exclusion is expressly stated.

As used herein, language such as “one or more Xs” shall be considered synonymous with “at least one X” unless otherwise expressly specified. Any recitation of “one or more Xs” signifies that the described steps, operations, structures, or other features may, e.g., include, or be performed with respect to, exactly one X, or a plurality of Xs, in various examples, and that the described subject matter operates regardless of the number of Xs present, as long as that number is greater than or equal to one.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Although some features and examples herein have been described in language specific to structural features and/or methodological steps, it is to be understood that the appended claims are not necessarily limited to the specific features or steps described herein. Rather, the specific features and steps are disclosed as preferred forms of implementing the claimed invention. For example, network 306, processors 312 and 324, and other structures or systems described herein for which multiple types of implementing devices or structures are listed can include any of the listed types, and/or multiples and/or combinations thereof.

Moreover, this disclosure is inclusive of combinations of the aspects described herein. References to “a particular aspect” (or “embodiment” or “version”) and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting.

It should be emphasized that many variations and modifications can be made to the above-described examples, the elements of which are to be understood as being among other acceptable examples. All such modifications and variations are intended to be included herein within the scope of this disclosure and protected by the following claims. Moreover, in the claims, any reference to a group of items provided by a preceding claim clause is a reference to at least some of the items in the group of items, unless specifically stated otherwise. This document expressly envisions alternatives with respect to each and every one of the following claims individually, in any of which claims any such reference refers to each and every one of the items in the corresponding group of items. Furthermore, in the claims, unless otherwise explicitly specified, an operation described as being “based on” a recited item can be performed based on only that item, or based at least in part on that item. This document expressly envisions alternatives with respect to each and every one of the following claims individually, in any of which claims any “based on” language refers to the recited item(s), and no other(s). Additionally, in any claim using the “comprising” transitional phrase, recitation of a specific number of components (e.g., “two Xs”) is not limited to embodiments including exactly that number of those components, unless expressly specified (e.g., “exactly two Xs”). However, such a claim does describe both embodiments that include exactly the specified number of those components and embodiments that include at least the specified number of those components.

Some operations of example processes or devices herein are illustrated in individual blocks and logical flows thereof, and are summarized with reference to those blocks. The order in which the operations are described is not intended to be construed as a limitation unless otherwise indicated. Any number of the described operations can be executed in any order, combined in any order, subdivided into multiple sub-operations, or executed in parallel to implement the described processes. For example, in alternative implementations included within the scope of the examples described herein, elements or functions can be deleted, or executed out of order from that shown or discussed, including substantially synchronously or in reverse order.

1. A method comprising, by an authorization server of a telecommunications network:
determining that a terminal is roaming in the telecommunications network;
receiving service data associated with the terminal of the telecommunications network from a home authorization server of a home network via a communications interface;
determining that a portion of the service data corresponds with a predetermined network service not supported by the telecommunications network;
determining modified service data to remove the ability of the terminal to use the predetermined network service not supported by the telecommunications network but supported by the home network at least partly by removing the portion of the service data; and
transmitting, via the communications interface, the modified service data to a control device of the telecommunications network.

2. (canceled)

3. The method according to claim 1, further comprising, by the authorization server, determining the portion of the service data excludes a flag indicating whether voice sessions are permitted over packet-switched transports.

4. The method according to claim 1, further comprising, by the authorization server, determining the portion of the service data comprises a service-selection value.

5. The method according to claim 1, further comprising, by the authorization server:
receiving, via the communications interface, identification information associated with the terminal; and
retrieving the service data associated with the terminal from the home authorization server associated with the identification information via the communications interface.

6. The method according to claim 1, wherein the predetermined network service comprises a packet-switched media service.

7. The method according to claim 6, wherein the packet-switched media service comprises Voice over Long-Term Evolution (VoLTE) and the authorization server comprises a Diameter Routing Agent (DRA).

8. A system, comprising:
an authorization server of a telecommunications network, the authorization server configured to:
receive service data associated with a terminal roaming in the telecommunications network from a home authorization server of a home network via a communications interface;
determine that a portion of the service data corresponds with a predetermined network service not supported by the telecommunications network;
determine modified service data to remove the ability of the terminal to use the predetermined network service not supported by the telecommunications network but supported by the home network at least partly by removing the portion of the service data; and
transmit, via the communications interface, the modified service data to a control device of the telecommunications network;
a control device of a telecommunications network, the control device configured to:
receive the modified service data;
determine a gateway device identified in the modified service data; and
transmit, via the communications interface, an association message to the gateway device on behalf of the terminal.

9. (canceled)

10. The system according to claim 8, wherein the authorization server is further configured to determine the portion of the service data excludes a flag indicating whether voice sessions are permitted over packet-switched transports.

11. The system according to claim 8, wherein the authorization server is further configured to determine the portion of the service data comprises a service-selection value.

12. The system according to claim 8, wherein the authorization server is further configured to:
receive, via the communications interface, identification information associated with the terminal; and
retrieve the service data associated with the terminal from the home authorization server associated with the identification information via the communications interface.

13. The system according to claim 8, wherein the control device is further configured to:
receive an association response from the gateway device; and
transmit at least a portion of the association response to the terminal via the communications interface.

14. A system, comprising:
an authorization server of a telecommunications network, the authorization server configured to:
receive service data associated with a terminal of the telecommunications network from a home authorization server of a home network via a communications interface, wherein the terminal is roaming;
determine that a portion of the service data corresponds with a predetermined network service not supported by the telecommunications network;
determine modified service data to remove the ability of the terminal to use the predetermined network service not supported by the telecommunications network but supported by the home network at least partly by removing the portion of the service data; and
transmit, via the communications interface, the modified service data to a control device of the telecommunications network;
a control device of a telecommunications network, the control device configured to:
receive the modified service data;
receive a request for a network service from the terminal;
determine that the modified service data does not authorize the network service; and
transmit, via the communications interface, a rejection message to the terminal.

15. (canceled)

16. The system according to claim 14, wherein the authorization server is further configured to determine the portion of the service data excluding a flag indicating whether voice sessions are permitted over packet-switched transports.

17. The system according to claim 14, wherein the authorization server is further configured to determine the portion of the service data comprising a service-selection value.

18. The system according to claim 14, wherein the authorization server is further configured to:
receive, via the communications interface, identification information associated with the terminal; and
retrieve the service data associated with the terminal from the home authorization server associated with the identification information via the communications interface.

19. The system according to claim 14, wherein:
the request for the network service includes a service-selection value;
the modified service data comprises one or more permitted service-selection values; and
the determining that the modified service data does not authorize the network service comprises determining that the one or more permitted service-selection values do not include the service-selection value.

20. The system according to claim 14, wherein the predetermined network service comprises Voice over Long-Term Evolution (VoLTE) and the control device comprises a Mobility Management Entity (MME).
